(19) United States
(12) Patent Application Publication
(10) Pub. No.: US 2003/0192485 A1
(43) Pub. Date: Oct. 16, 2003

(54) Method and systems for disinfecting animal bedding and stalls

(76) Inventor: William Opfel, Mesa, AZ (US)

Correspondence Address: Kenneth C. Booth, Schmeiser, Olsen & Watts LLP, 18 East University Drive, #101, Mesa, AZ, 85201, US

(21) Appl. No.: 10/411,017

(22) Filed: Apr. 9, 2003

Related U.S. Application Data
(63) Continuation-in-part of application No. 10/120,858, filed on Apr. 10, 2002.
(63) Continuation-in-part of application No. 10/188,611, filed on Jul. 2, 2002.
(60) Provisional application No. 60/431,067, filed on Dec. 4, 2002.
(60) Provisional application No. 60/371,783, filed on Apr. 10, 2002.

(51) Int. Cl. A01K 1/015

(52) U.S. Cl. 119/526

(57) ABSTRACT

Animal bedding disinfecting methods and systems are disclosed that facilitate removal of contaminants and pathogens from reusable animal bedding. A disinfecting method includes: preparing soiled animal bedding for disinfecting; disinfecting the soiled animal bedding; and reusing the disinfected animal bedding. A disinfecting system for supplying at least one disinfecting medium to animal bedding includes: a cover configured to create a controlled environment around the animal bedding; and at least one disinfecting medium reservoir associated with the cover configured to supply at least one disinfecting medium to the animal bedding within the controlled environment. A disinfecting system for supplying heat to animal bedding includes a heating cover configured both to create a controlled environment around the animal bedding and to supply heat at a temperature of at least approximately 200° F. for a time period of at least approximately 5 minutes to the animal bedding.

### CROSS REFERENCE TO RELATED APPLICATIONS

This application claims priority to U.S. Provisional Patent Application to William Opfel entitled “METHOD AND SYSTEMS FOR DISINFECTING ANIMAL LITTER AND STALLS”, serial No. 60/431,067, filed Dec. 4, 2002, now pending, and is a continuation-in-part of both the earlier U.S. Utility Patent Application to William Opfel entitled “ANIMAL LITTER AND METHODS OF FABRICATING SAME,” Ser. No. 10/120,858, filed Apr. 10, 2002, now pending, and the earlier U.S. Utility Patent Application to William Opfel entitled “CLEANING SYSTEM FOR ANIMAL LITTER AND BEDDING,” Ser. No. 10/188,611, filed Jul. 2, 2002, which claims priority to U.S. Provisional Patent Application to William Opfel entitled “CLEANING SYSTEM FOR ANIMAL LITTER”, serial No. 60/371,783, filed Apr. 10, 2002, now pending, and claims priority to U.S. Provisional Patent Application to William Opfel entitled “CLEANING SYSTEM FOR ANIMAL LITTER”, serial No. 60/371,783, filed Apr. 10, 2002, now pending, and claims priority to the U.S. Provisional Patent Application to William Opfel entitled “VENTING SYSTEM FOR ANIMAL STALL,” serial No. 60/431,140, filed Dec. 4, 2002, and claims priority to the U.S. Patent Application to William Opfel entitled “ANIMAL ARENA SURFACE AMENDMENT,” Ser. No. 10/158,676, filed May 29, 2002, the disclosures of which are hereby incorporated herein by reference.

### BACKGROUND OF THE INVENTION

1. Technical Field

This invention generally relates to animal husbandry, and more specifically relates to a method and systems for disinfecting animal stalls and animal bedding for reuse.

2. Background Art

In order to maintain health, animals placed in stalls or any other form of confinement (e.g. horses in horse stalls) require appropriate bedding in the large animal industry (collectively referred to herein as “bedding”), and diligent stall and bedding maintenance, including cleaning and disinfecting. Controlling the condition of stalls and bedding in animal stalls is essential to ensure a better environment and thus better health and performance of the animals. The condition or quality of stalls and bedding can be affected by a number of factors such as moisture, temperature, pH, ventilation, stocking density, and frequency of cleanout.

Stalls and animal bedding are common hiding places for many contaminants such as animal hair and fur, dander, dust mites, dust, dirt, protein and irritating gases (e.g. ammonia and hydrogen sulfide) from decomposing animal waste, and the like (collectively referred to herein as “contaminants”), and for pathogens such as bacteria, viruses, fungi and molds, other pathogens, and the like (collectively referred to herein as “pathogens”). Contaminants and pathogens may be a problem not only for the animal using the stall and bedding, but also for the caregivers of the animal. Both the animal and the caregiver may develop diseases, respiratory ailments and diseases, allergies, hair loss, rashes, other sanitation problems, and the like from contaminants and pathogens present in the animal bedding.

As one example, ammonia is a noxious gas that is produced by the microbial decomposition of nitrogenous waste in the bedding along with other processes. The deleterious effects of ammonia on animal performance and health have been well documented. The presence of ammonia is a major physiological stress agent that is directly related to the health of the animal. This results in lower weight gain and generally unhealthy animals. Mortality also increases. Prolonged ammonia exposure at concentrations higher than 25 ppm (parts per million) has been shown to denude the respiratory tree cillia and leave the animals vulnerable to challenges from respiratory ailments. A primary method used for controlling ammonia levels is a properly designed stall complete with an above ground ventilation system. Key components of the ventilation system may be proper inlet location, air direction, air speed, and volume of air. However, older facilities that do not have modem designs or sophisticated ventilation systems are looking at substantial expenses in order to remedy the situation. Also, the energy requirements to maintain a ventilation system are quite high. Further, higher levels of ventilation lead to lower temperatures that are not always tolerated well by animals.

In addition to ammonia, the proliferation of pathogenic microorganisms is also a major problem. Strangles, influenza, salmonellosis, rotavirus, herpesvirus, and the like infectious disease outbreaks are costly when considering the value of the horse, lost performance time, missed breeding dates, veterinary treatment and control measures. For example, equine herpes is a severe problem for stalled horses caused by the presence of the herpesvirus in horse bedding and stalls, and outbreaks of equine herpes lead to quarantine of the horse(s) for long periods of time. Caked and damp bedding leads to increased pathogenic microbial growth further affecting the health of and inhibiting the performance of the animals. Spilled feed further compounds the problem since spilled feed and moisture lead to rapid proliferation of these microorganisms. A further problem is caused by excess water accumulating on the bedding surface and increasing moisture content. This environment results in a high pathogenic microbial population in the bedding.

There are a number of conventional bedding materials for animals. For example, conventional bedding materials for animals such as horses include natural organic materials, sand, clay, sand/clay mixtures, limestone dust, wood, concrete, and asphalt flooring, rubber floor mats, volcanic cinders, baking soda, zeolites, and potassium dichromate.

Natural organic bedding materials such as alfalfa, straw, saw dust, wood shavings, rice hulls, and grass have been used for bedding materials in animal stalls and like places where bedding animals such as horses, cattle, domestic pets, laboratory animals and the like typically rest. However, these natural organic materials present fire hazards, are prone to being accompanied by dust, dirt, manure fines, and organisms that are not conducive to the health of the animals. Additionally, spoiled natural organic bedding material must be replaced frequently, even daily, in order to keep the stalls and the like at least somewhat sanitary. While this is obviously an effective way to control and immediately improve bedding quality, this method of improving bedding quality is becoming less of an option. The replacement and disposal of 50-100 pounds or more of soiled bedding materials per stall can become a problem for the user, especially since there are limited disposal options for urine and manure-soaked organic bedding. Additionally, the costs of purchasing organic materials for animal bedding have increased as other industries compete for these organic materials. Also, these organic bedding materials are not reusable since use of built-up organic bedding leads to an increase in the populations of microbial pathogens in the bedding and excessive ammonia production.

Stalls using only sand must be cleaned regularly and the sand changed regularly. It is a poor bedding choice for many horses due to dust and the potential for colic. Conventional clay floorings or clay/sand mixture floorings require relatively high maintenance and do not provide dust free environments because of the inadequate hardness of the clay materials. Conventional clay materials are not long lasting, and attrition leads to additional dust as the clay material ages in the stall. In addition, packed clay floors tend to become slippery when wet, and maintaining a level clay floor is difficult and time consuming. Furthermore, when horses urinate and then paw or move about the stall, holes and pockets develop in both the clay and clay/sand mixture floorings. Stall cleaning becomes difficult and drainage and odor problems often result.

Stall floors constructed of limestone dust inhibit ammonia odors. Limestone dust is usually placed over sand to allow adequate drainage, and the lime flooring is watered and packed before use. However, as installed, this flooring is not safe for use around people or horses. Lime flooring often has the same colic problems associated with sand, clay, and clay/sand mixture floors. In addition, lime is strongly alkaline and may cause drying and irritation of skin and respiratory organs. A horse fed off lime flooring may develop damage to its mouth, throat, and internal organs. Horses may also develop rashes from contact with lime. Furthermore, lime flooring is often as hard as concrete floors, and additional bedding (straw, sawdust, wood shavings, stone dust, sand, clay, soil, etc.) is required to provide sufficient bedding/cushioning for horses. Baking soda is safer to use and more effective than lime at reducing odors. However, it has almost no absorbency, which would require large amounts to be used in a stall. Baking soda and 15-30 gallons of urine for example would become sticky and contribute to a stall moisture problem.

Wooden floors are expensive, require chemical treatment to retard decay, are slippery when wet, and require additional bedding to provide sufficient cushioning for horses and to absorb urine and avoid odor. Concrete or asphalt stall flooring have very poor drainage, are often cold and slippery, and additional bedding topping is necessary to absorb urine and avoid odor, provide traction, and avoid increased leg problems. Rubber stall mats, rubber paving bricks, and fiber-reinforced polyethylene interlocking blocks also are expensive and also require additional bedding to absorb urine and avoid odor. These systems are subject to destruction by an animal's hoofs and tend to accumulate excretory material on their underside, causing a stall air quality and bedding disposal problem.

Horse bedding produced from volcanic cinders (siliceous materials) is very dusty to begin with, and even more dust is created by attrition because large closed pores (fossil gas bubbles) make cinders soft with a low crush strength, thereby providing a respirable silica dust hazard. Volcanic cinders also have low absorbency. The large closed pores on a cinder do not have sufficient chemical-electrical attraction and large surface areas to absorb urine and avoid odor.

Zeolite products have the disadvantage that they are difficult to produce without dust. Most zeolites are absorbent, but lack the degree of hardness necessary to ensure that they will not grind to dust under a horse's hooves. Potassium dichromate serves to kill odor-producing bacteria and neutralize organic molecules that produce odors. However, although potassium dichromate reduces odors, it is not hard, grinds to dust under a horse's hooves, and is toxic in certain situations.

Aside from the drawbacks of conventional bedding materials, few, if any, systems and disinfecting methods are available to improve bedding quality and for easily removing or eradicating contaminants and pathogens from animal bedding to enable the bedding to be reused without the contaminants and pathogens. Disinfectants have been used by some to coat the surface of the bedding. However, conventional surface applications of a disinfectant only temporarily slow microbial growth. Because maintaining a lethal concentration of disinfectant is critical to its efficacy, bedding would have to be saturated with the disinfecting agent and thoroughly mixed to ensure exposure to a lethal concentration of the disinfectant to be truly effective.

Accordingly, because animal bedding materials used for stall floors greatly influences air quality, ease of stall maintenance, and contaminant removal, what is needed is: 1) stall floors comprising bedding materials that are absorbent, dry, easy to clean, disinfect, and maintain, resistant to pawing, long lasting and durable, reusable, dust and odor free, and inexpensive; and 2) bedding maintenance systems and procedures for effectively cleaning and disinfecting contaminants and pathogens from stalls and associated animal bedding.

### DISCLOSURE OF THE INVENTION

The present invention may be readily adapted to a variety of animal litters and methods and systems for disinfecting animal stalls and associated animal bedding. Through the use of embodiments of the present invention, contaminants and pathogens may be removed from stalls and animal bedding to protect the animal and to extend the useable life of the bedding.

Animal litters for use and reuse according to the invention may be, among other characteristics: hard, long lasting and durable; reusable; highly absorbent; dust and odor free; easy to disinfect, clean and maintain; and inexpensive. In particular embodiments, the present invention provides an animal bedding composition comprising granules having calcium bentonite clay, illite clay, and/or kaolinite clay.

A method of disinfecting the animal bedding according to the invention may include: preparing soiled animal bedding for disinfecting; disinfecting the soiled animal bedding; and reusing the disinfected animal bedding. An additional step may include removing the animal bedding. An animal bedding disinfecting system according to the invention may supply at least one airborne disinfecting medium to animal bedding to disinfect the animal bedding for reuse. The disinfecting system may include: a cover configured to create a controlled environment around the animal bedding; and at least one disinfecting medium reservoir associated with the cover configured to supply at least-one disinfecting medium to the animal bedding within the controlled environment.

The foregoing and other features and advantages of the invention will be apparent to those of ordinary skill in the art from the following more particular description of the invention and the accompanying drawings.

### BRIEF DESCRIPTION OF THE DRAWINGS

The invention will hereinafter be described in conjunction with the appended drawings, where like designations denote like elements, and:

FIG. 1 is a flow diagram illustrating a disinfecting method according to an embodiment of the invention;

FIG. 2 is a side view of a horse stall and a disinfecting system according to an embodiment of the invention during the disinfecting method of FIG. 1;

FIG. 3 is a side view of a horse stall and a disinfecting system according to another embodiment of the invention during the disinfecting method of FIG. 1;

FIG. 4 is a side view of a horse stall and a disinfecting system according to still another embodiment of the invention during the disinfecting method of FIG. 1;

FIG. 5 is a side view of a horse stall and a disinfecting system according to yet another embodiment of the invention during the disinfecting method of FIG. 1;

FIG. 6 is a side view of a horse stall and a disinfecting system according to even another embodiment of the invention during the disinfecting method of FIG. 1; and

FIG. 7 is a side view of a horse stall and a disinfecting system according to another embodiment of the invention during the disinfecting method of FIG. 1.

### DESCRIPTION OT THE INVENTION

1. Overview, Terminology, and Definitions

The invention is particularly useful in disinfecting and cleansing horse stalls to separate the horse bedding from the contaminants and pathogens that collect in the horse bedding over time and present health risks to the horse, and return the horse bedding for continued use. Embodiments of the invention prolong the usefulness of the horse bedding, promote a healthy environment for the horse, and reduce the overall maintenance and health care costs for the horse.

However, it will be understood by those of ordinary skill in the art that the invention is not limited to uses relating to horses and horse stalls, or for that matter trailers, barns, corrals, arenas, racetracks, and the like. Rather, any description relating to horses and the like is for the exemplary purposes of this disclosure, and those of ordinary skill in the art will also understand that the invention may also be used in a variety of applications with similar results for a variety of animals, such as in stalls, cages, kennels, trailers, racetracks, arenas, and the like for animals including, among others: animals such as cats, dogs (including racing dogs like greyhounds), gerbils, guinea pigs, mice, rats, hamsters, rabbits, ferrets, and skunks; laboratory animals; farm animals, such as chickens and other poultry, goats, sheep, pigs, cows, elk, and deer; and zoo animals.

Moreover, it will be understood by those of ordinary skill in the art that the invention is not limited to the specific litters and implementing components disclosed herein, as virtually any litters and implementing components known in the art consistent with the intended operation of a method and/or system of the invention for disinfecting animal stalls and associated animal bedding may be utilized. Accordingly, for example, although particular litters and disinfecting methods, disinfecting mediums, disinfecting systems, cleaning devices, covers, drying devices, heating devices, torching devices, kilns, irradiating devices, applicators, baths, tanks, canisters, venting systems, control devices, sensors, and other implementing components are disclosed, such litters and components may comprise any shape, size, style, type, model, version, measurement, concentration, material, and/or the like as is known in the art for such litters and components consistent with the intended operation of a method and/or system of the invention for disinfecting animal stalls and associated animal bedding. It will also be understood by those of ordinary skill in the art that the invention is not limited to use of any specific bedding or implementing components, provided that the bedding and components selected are consistent with the intended operation of a method and/or system of the invention for disinfecting animal stalls and associated animal bedding.

In describing and claiming the present invention, the following terminology will be used in accordance with the definitions set out below. Notwithstanding, other terminology and definitions may also be found throughout this disclosure as well.

As used in this disclosure and the patent applications incorporated herein by reference, the term “litter” and “animal litter” is considered to be interchangeable with the terms “bedding” and “animal bedding”. In the small animal industry, for example the cat industry, the terms “litter” and “animal litter” are commonly used to refer to the material on which the animal urinates or defecates. In the large animal industry, and particularly the horse industry, the convention is to use the terms bedding and animal bedding rather than litter and animal litter. This may be because the large animals often sleep in the area in which the animal litter is placed. Despite the difference in term usage in different industries, to simplify use for the purposes of this disclosure which relates to animal bedding for animals of all sizes, the term “bedding” is intended to encompass “litter”, and “bedding” may be used interchangeably with “litter.”

As used herein, “stall” refers to any structure that is configured to confine an animal in any manner for any amount of time such as stalls, portable stalls, trailers, barns, corrals, stables, arenas, racetracks, cages, pens, kennels, housings, boxes, bedding boxes, and the like.

As used herein, “contaminants” refer to such materials as dust, dirt, sand, hay, straw, sawdust, feed, hair, fur, dander, dust mites and other small pests, animal waste, proteins and irritating gases (e.g. ammonia) from decomposing animal waste, pollen, spores, germs, toxins, cobwebs, fly “tracks”, saliva, mucous and other nasal discharges, sweat, blood, scabs, other debris which are typically wind-blown, other common allergens and risks for respiratory infections and diseases, and the like.

As used herein, “pathogens” refer to microbial contaminants such as bacteria, viruses, fungi and molds, other pathogens, and the like.

As used herein, “soiled” animal bedding refers to any bedding from an animal occupied stall environment that has received any amount of animal waste thereon and/or contains any contaminants and/or pathogens.

As used herein, “disinfecting” refers to the cessation of growth, the regression, or the disappearance of detectable pathogens, or a diminution in the spread of pathogens.

2. Detailed Description

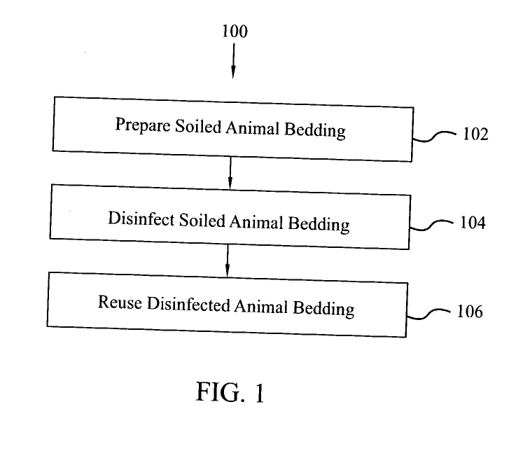

Turning now to FIG. 1, exemplary disinfecting method 100 for disinfecting an animal stall and associated bedding composition in accordance with embodiments of the invention are illustrated. Generally, and for the exemplary purposes of this disclosure, method 100 may disinfect an animal stall and associated bedding composition for reuse by: preparing a stall and/or soiled animal bedding for disinfecting (step 102); disinfecting the stall and/or soiled animal bedding (step 104); and reusing the disinfected stall and/or animal bedding (step 106).

Step 102 of method 100 is to prepare a stall and/or soiled animal bedding for disinfecting. Animal bedding in step 102 may comprise virtually any animal bedding, even disadvantageous conventional animal litters. Accordingly as described previously, conventional bedding materials for animals such as horses may include natural organic materials (e.g. saw dust, wood shavings, rice hulls, straw, alfalfa, and grass), sand, clay, sand/clay mixtures, limestone dust, wood flooring, concrete flooring, asphalt flooring, rubber floor mats, synthetic pellets or rods, volcanic cinders, baking soda, zeolites, and potassium dichromate. Notwithstanding, for the exemplary purposes of this disclosure, the granular clay compositions provided or formed as disclosed in the co-pending patent application to William Opfel entitled “ANIMAL LITTER AND METHODS OF FABRICATING SAME,” Ser. No. 10/120,858, filed Apr. 10, 2002, the disclosure of which is hereby incorporated herein by reference and summarized by the following explanation, are examples of animal litters that may be disinfected according to method 100.

For example, an appropriate horse bedding sold under the name Equidry™ may be obtained through Equidry Bedding Products, Arizona. Granular clay compositions such as Equidry™ have superior absorbency and wicking, and sufficient hardness to not become significantly crushed during use and the preparation process, and therefore keep stall environments clean and dry. High absorbency and surface areas are achieved as a result of porosity enhancing techniques (e.g. acid activation or bloating by kilning) and the resulting microporosity and macroporosity of the clay granules.

Accordingly, such granular clay compositions may comprise granules having at least calcium bentonite clay, illite clay, and/or kaolinite clay respectively combined in any percentage by weight, depending upon the particular needs of an application, to form any animal bedding for use in various applications from large animal stalls to small animal stalls. Different percentages by weight affect absorbancy and hardness and may be verified by X-Ray diffraction techniques well known to those of ordinary skill in the art. For example, in some embodiments of the invention, the calcium bentonite clay, the illite clay, and the kaolinite clay may be respectively combined in a percentage by weight of approximately 72%:17%:11% to approximately 15%:29%:56%. In other embodiments of the invention, the calcium bentonite clay and one of the illite clay and the kaolinite clay may be respectively combined in a percentage by weight of approximately 85%:15% to approximately 15%:85%. In still other embodiments of the invention, the calcium bentonite clay, the illite clay, and the kaolinite clay may be combined with other minor constituents, such as chlorite clay, quartz, calcite, K-feldspar, hematite, plagioclase, and unaccounted materials, and comprise a chemical analysis approximately as follows:

| | Approximate Percentage |
|---|---|
| Component | (%) of Weight |
| Calcium Bentonite | 48-8 |
| Illite | 11-12 |
| Kaolinite | 7-27 |
| Chlorite | 0-5 |
| Quartz | 10-29 |
| Calcite | 4-5 |
| K-Feldspar | 2-4 |
| Hematite | 12-0 |
| Plagioclase | 3-7 |
| Unaccounted materials | 3-3 |

Additionally, the animal bedding composition may comprise any size or size range granules having at least calcium bentonite clay, illite clay, and/or kaolinite clay respectively, again depending upon the particular needs of an application, to form any animal bedding for use in various applications from large animal stalls to small animal cages. An animal bedding having a given range of granule sizes may also differ in the distribution or proportion of granules having each particular size. Thus, an animal bedding composition according to embodiments of the invention may be a mixture of differently sized granules, which is more absorbent than when all granules are the same size. However, the animal bedding may be a mixture of similarly sized granules as well. Accordingly, mixtures of different granule sizes allow for higher absorbency and different animal support characteristics (e.g. animal ground pressure support). For example, granule mixes with increased amounts of material sized in the 14-50 mesh range to maximize absorbency will be of advantage to animal litters requiring very high wicking capacities along with a reduced concern for a breakdown of product (attrition losses), such as in embodiments for bedding boxes for small pets. While inclusion of fines (40 mesh granules or smaller) actually helps to increase the wicking capacity of an animal bedding composition, in embodiments for equestrian uses the fines would need to be minimized or eliminated to avoid the potential for sand colic (sand ingestion and compaction in bowels).

For example, in some embodiments of the invention, the granules of the animal bedding composition may comprise a mixture of granule sizes from 4-14 mesh formed from approximately 8-14 mesh granules and approximately 4-8 mesh granules combined in a respective percentage by weight of approximately 60%:40%. In other embodiments of the invention, the granules of the animal bedding composition may comprise a mixture of granule sizes from 6-20 mesh formed from approximately 12-20 mesh granules and approximately 6-12 mesh granules combined in a respective percentage by weight of approximately 50%:50%. This mixture allows for high absorbency while allowing larger granules to mask the presence of the smaller granules. That is, the 12-20 mesh granules exist in the intragranular spaces where they are hidden from view and incapable of being segregated and ingested by the animal. In still other embodiments of the invention, the granules of the animal bedding composition may comprise a mixture of granule sizes from 6-50 mesh formed from approximately 20-50 mesh granules and approximately 6-20 mesh granules combined in a respective percentage by weight of approximately 50%:50%. In yet other embodiments of the invention, the granules of the animal bedding composition may comprise a mixture of granule sizes from 6-20 mesh formed from approximately 14-20 mesh granules and approximately 6-14 mesh granules combined in a respective percentage by weight of approximately 50%:50%. In even other embodiments of the invention, the granules of the animal bedding composition may comprise a mixture of granule sizes from 8-50 mesh formed from approximately 20-50 mesh granules and approximately 8-20 mesh granules combined in a respective percentage by weight of approximately 50%:50%. Those of ordinary skill in the art will understand the benefits and trade-off of hardness and absorbency resulting from various mixtures of mesh sizes and will be able to readily select an appropriate combination and distribution of mesh sizes for a particular application from the disclosure provided herein.

Accordingly and for the exemplary purposes of this disclosure, granular clay horse bedding compositions for use with the present invention may be those having: a density of approximately 20-70 lbs/ft³; an LA Abrasion hardness value of approximately 20-30; and a size of approximately 4-20 mesh; a surface area of approximately 20,000,000-60,000,000 ft²/ft³; an absorption capacity of approximately 0.5 ml/g-2.5 ml/g, or more specifically approximately 1.4 ml/g-1.9 ml/g; and an absorption rate of approximately 90 milliliters or more within 10 minutes.

Such a granular horse bedding composition may be placed on the floor of a horse stall to a depth of approximately 2 inches to 8 inches or more in preparation for introducing a horse to the stall. The horse bedding then absorbs and desiccates the waste deposited by the horse over time. The absorption of moisture from the horse fecal waste leaves it desiccated so that it is not as offensive in odor production as its moist counterpart. Over time, absorbed moisture and ammonia are dissipated from the surface and porous structures of the horse bedding granules with the result that moisture/odor is controlled along with a corresponding reduction in fly problems. Therefore, the horse bedding reduces wet spots in the stall, and in doing so chemically ties up or partitions off the bulk of ammonia in the horse's wastes leaving a clean and relatively odor free stall environment.

Additionally, because the horse bedding composition granules are sufficiently hard, they have a very high resistance to crushing/powdering under the horse's weight. In addition, there is less dust produced when the horse kicks up the hard granules, or when horse bedding is placed in the stall. Moreover, the granule sizing reduces stall digging/pawing by the horse. The free-flowing ability of the granules discourages and eliminates the horse's digging efforts. As the horse attempts to dig in the bedding, the hole continues to fill in with the free flowing granules. Furthermore, during use, the horse bedding does not get tangled in the horse's mane or tail and the horse's hooves stay better conditioned since the bedding does not pack along side the hoof frogs.

Preparing a stall and/or soiled animal bedding for disinfecting in step 102 may involve any number of steps and implementing components, and preparing a stall and soiled animal bedding may be accomplished readily by those with ordinary skill in the art from the disclosure herein. Preparing a stall and soiled animal bedding may be accomplished with the bedding in place (in situ) or removed from the stall depending on among other considerations the subsequent disinfecting method and/or system to be utilized.

Whether in situ or not, stalls and bedding may have fines and irritating gases (e.g. ammonia) introduced by the horse's waste breakdown, animal hair and fur, dander, dust mites, dust, dirt, and other contaminants and possibly some of its pathogens removed first so that the bedding may be disinfected subsequently. While such contaminants do not necessarily have to be removed from the bedding prior to disinfecting, removal of the contaminants will allow the stall and bedding to be more effectively and/or efficiently disinfected. Moreover, some disinfectants may be inactivated in the presence or organic contaminants, and therefore, they would need to be removed from the stall and bedding prior to disinfecting.

For the exemplary purposes of this disclosure, stalls and animal bedding may have their contaminants and possibly some of their pathogens removed with cleaning systems such as a vacuum and/or blower, which may include additional mechanical agitation. Particularly useful to the present invention may be any of the cleaning systems and services provided by and through Equidry Bedding Products, Arizona for removing contaminants from animal bedding. Examples of Equidry Bedding Products, Inc. cleaning systems are shown and described in the co-pending patent application to William Opfel entitled “CLEANING SYSTEM FOR ANIMAL LITTER AND BEDDING,” Ser. No. ______, filed ______, the disclosure of which is hereby incorporated herein by reference and summarized by the following explanation.

Accordingly, such cleaning systems may remove contaminants from animal bedding by stirring up the relatively heavy animal bedding to gain access to and loosen relatively light contaminant material for removal from the bedding. In a first embodiment of the invention, a blower for producing a fluid stream from a cleaning system and a vacuum for producing a fluid stream into the cleaning system are used simultaneously. The blower is configured to blow a first fluid stream, such as an air stream, toward an animal bedding target to be cleaned with enough force to raise the animal bedding from the surface on which it lays into temporary suspension in the first fluid stream. The vacuum is configured to simultaneously draw a second fluid stream into the cleaning system from the region of the target material with enough force to draw the material in and around the animal bedding, which is lighter than the animal bedding, from the fluid stream in which the animal bedding is temporarily suspended. The second fluid stream may then be filtered, for example, with a cleanable cloth bag filter, to remove any contaminants from the second fluid stream. Specific embodiments relating to the first embodiment of the invention may include a fluid stream deflection plate or other enclosed shroud to control contamination being blown away to the surrounding environment by the blower fluid stream.

In a second embodiment of the invention, a vacuum for producing a fluid stream into a cleaning system is used to draw a stream of animal bedding and contaminants from an animal stall, or other area to be cleaned, into the cleaning system. The fluid stream is then drawn through a separation chamber, such as a cyclonic or other separator, to separate the relatively heavier animal bedding from relatively lighter contaminants. The contaminants are drawn away from the animal bedding and are filtered from suspension in the fluid stream. Specific embodiments relating to the second embodiment of the invention include a separation chamber configured with one or more straps for a user to carry, configured with wheels for a user to roll between locations to be cleaned, and larger configurations to be carried on or behind a truck.

In a third embodiment of the invention, mechanical agitation is used to throw the animal bedding against an impact plate or a second stream of animal bedding to further shake contaminants loose or at least move the animal bedding off of the ground into a fluid stream. The fluid stream draws the lighter contaminants from among the heavier animal bedding material into a vacuum for disposal or further filtering, and the heavier animal bedding falls to the ground. In one particular example of the third embodiment, a rotor with agitating blades is used to throw the animal bedding against the impact plate within a shroud. In another particular example, two or more rotors with agitating blades may be used, each throwing respective streams of animal bedding against each other within a shroud. In yet another particular example, a conveyor moves the contaminated animal bedding into a fluid stream which blows fluid, such as air, through the animal bedding as it falls to the ground. A vacuum draws the contaminants from the fluid stream and leaves the animal bedding to return to the ground. Additional filtering of contaminants may be performed in the vacuum such as separation of contaminants from the fluid stream to create an uncontaminated fluid stream for reuse or to return to the environment, and separation of different categories of contaminants, for example, light and heavy contaminants. The first and second embodiments may also be enhanced by forms of mechanical moving or agitation of the animal bedding prior to cleaning in the fluid stream.

Notwithstanding, animal bedding and stalls may have their contaminants and possibly some of their pathogens removed by washing bedding and stall surfaces with a detergent to remove as much soil and organic matter as possible. Even the best disinfectants do not work effectively when poured directly on organic debris. Additionally, using an anionic detergent, as opposed to cationic and nonionic detergents, should not interfere with the subsequent actions of disinfectants, such as phenols. For the exemplary purposes of this disclosure, this approach is advantageous for stalls with varnished wood, painted concrete block, and the like surfaces with a draining area. The stall surfaces may be swept and/or scrubbed to remove as much organic matter as possible. Then, using a hose with a spray nozzle, such as those attached to a steam cleaner for example, the bedding and stall surfaces may be cleaned using a detergent starting at the top of the stall, then working from the edges of the stall toward the draining area. After all surfaces are cleaned and rinsed, excess water may be removed, especially from floors, by using a broom or rubber scraper (squeegee), and the animal bedding and stalls should be dried or allowed to dry. While removing contaminants from animal bedding prior to disinfecting is not required in all embodiments of the invention, removal of contaminants significantly increases the efficiency and effectiveness of some of the disinfecting methods described herein.

Still referring to FIG. 1, step 104 of method 100 is to disinfect soiled animal bedding and/or stalls. As previously explained, it is advantageous for most, if not all, of the contaminants to be removed from the stall and soiled animal bedding prior to disinfecting so that the stall and bedding may be more effectively and/or efficiently disinfected subsequently and so that certain disinfectants will not be inactivated. Notwithstanding, disinfecting the stall and soiled animal bedding according to step 104 may be carried out whether or not the stall and soiled animal bedding was prepared according to step 102. Additionally, disinfecting the stall and soiled animal bedding may be accomplished with the bedding in situ or removed from the stall depending on among other considerations the disinfecting method and/or system to be utilized.

Several factors may be taken into consideration prior to disinfecting. Some considerations might include what types of stall surfaces need to be disinfected, what pathogens are of primary significance, and what disinfecting medium is going to have a reasonable expectation of efficacy under these circumstances. A wide range of disinfecting mediums are available. In determining which disinfecting medium to use, considerations such as choice of product, use concentration, and method of application, among others, may be considered. Inadequate disinfecting may have disastrous consequences, particularly in situations where a pathogen is known to be present (for example, following an infectious disease outbreak at an equine facility). Maintaining a lethal concentration of any disinfecting medium is advantageous to ensure that all pathogens in the animal bedding are eliminated. In some situations where the stall and soiled animal bedding was not prepared according to step 102, the disinfecting medium must be effective in the presence of organic matter in which the majority of pathogens are found. For example, Streptococcus equi, S. zooepidemicus, influenza, and herpesvirus are present in nasal discharges; Salmonella, E. coli, Actinobacillus and rotavirus are found in feces.

Some disinfecting mediums useful in embodiments of the invention may include hot water, steam, ozonated water, alcohols, gases (e.g. O₂, O₃, N₂, and CO₂), phenolics, hypochlorites, quaternary ammonium compounds, chlorohexidine, iodophors, pine oil, and the like, and synthetic substitutes, salts, esters, tautomers, isomers, analogs, and derivatives thereof, and/or any combination thereof. Because of their effectiveness even in the presence of organic matter, phenolics are recommended for use in horse facilities. Many different phenolic compounds are commercially available, such as Lysol®, Tek-Tro®, and 1 Stroke Environ®. Hypochlorites, such as bleach, and quaternary ammonium compounds are inactivated by organic matter. Iodophores, such as Betadine®, are effective even in the presence of organic matter. Chlorhexidines, such as Nolvasan® and Virusan™, and Pine oils, such as Pine Sol®, are inactivated by organic matter.

Disinfecting soiled animal bedding and/or stalls in step 104 may involve any number of steps and implementing components, and disinfecting soiled animal bedding and stalls may be accomplished readily by those with ordinary skill in the art from the disclosure herein.

In one embodiment of the invention, disinfecting soiled animal bedding according to step 104 may be accomplished by covering the soiled animal bedding and supplying an airborne disinfecting medium to the covered animal bedding. Covering soiled animal bedding may involve any number of steps and implementing components, and covering soiled animal bedding may be accomplished readily by those with ordinary skill in the art from the disclosure herein.

Accordingly, covering soiled animal bedding may be accomplished with any cover. Determining which type of cover to use will depend, among other factors, upon the disinfecting method, stall, and/or system to be utilized. Covers that are useful for embodiments of the present invention may include a cover (e.g. a blanket, a mat, a sheet, a tarp, a tent, a shroud, a hood, and the like), a heating cover, a reflective cover, a temperature resisting cover, a heating/reflective cover, a heating/reflective/temperature resisting cover, a container, a heating, sterilizing, irradiating, rinsing, and/or disinfecting device, any other similar cover, container, or device, and/or any combination thereof to create a substantially sealed, or at least partially sealed, controlled environment around the animal bedding. For example, silicone rubber laminated heating mats and blankets are resistant to moisture, weather, and most gases and chemicals, even ozone gases. Silicone rubber laminated heating mats and blankets are also easily applied to surfaces with adhesive tape or RTV cement, or could comprise pressure sensitive adhesive for quick-and-easy attachment. Silicone rubber laminated heating mats and blankets and other heating covers may require use with a controller. Covers may also be any shape and size. For example, a single cover may be large enough to use in a stall environment, or a plurality of covers may be removably coupled together (e.g. approximately 2′×6′ cover panels each having Velcro, snaps, or other fasteners on edges thereof for coupling with other cover panels).

In covering soiled animal bedding in situ or out of the stall, it is advantageous, though not necessary, to create a substantially sealed, or at least partially sealed, controlled environment around the animal bedding to more effectively and/or efficiently disinfect the soiled animal bedding. For example, the controlled environment may be created by merely placing a cover over the area, or by creating a substantially continuous seal around the perimeter of the area to trap the animal bedding between the cover and the ground or floor of the stall. For example, in situ the controlled environment may be created by coupling the cover to side walls of a stall using any coupling mechanism known in the art, such as tape, adhesive, fasteners (e.g. tacks or tack strips), and/or the like, thereby creating a partial seal around the inside perimeter of the stall to trap the animal bedding between the cover and the stall floor.

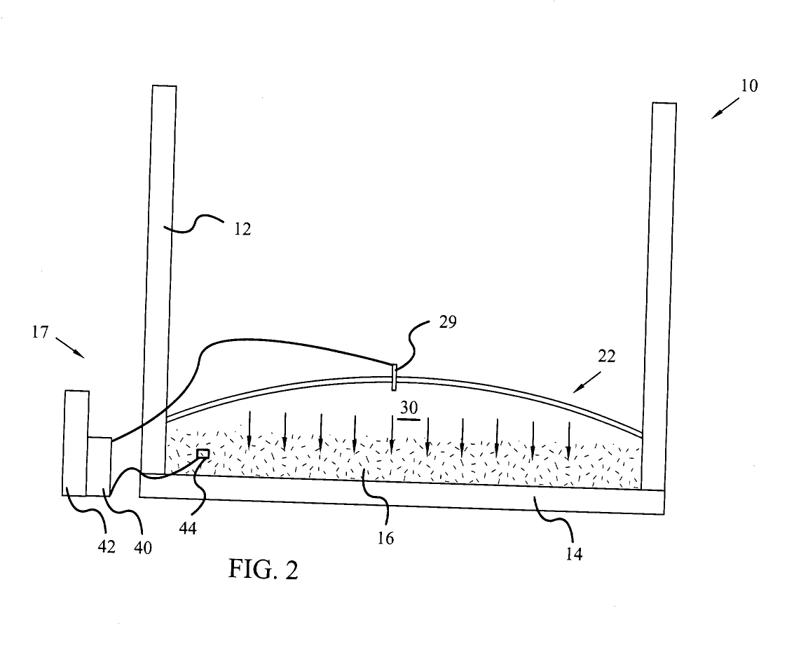

Supplying an airborne disinfecting medium may involve any number of steps and any disinfecting medium and implementing components, and supplying an airborne disinfecting medium may be accomplished readily by those with ordinary skill in the art from the disclosure herein. For example, an airborne disinfecting medium may be any airborne disinfecting medium, including a gas, an aspirated disinfectant, any other similar medium, and/or any combination thereof. As depicted in FIGS. 2-4 for example, supplying an airborne disinfecting medium to covered animal bedding in situ may be accomplished by supplying disinfecting medium from any disinfecting medium reservoir (e.g. a tank or an aerosol canister) through an inlet valve in or under the cover (e.g. a tarp) or through a venting system buried in the stall floor or built into geotextile flooring mats.

In a first embodiment, supplying an airborne disinfecting medium to covered animal bedding may be accomplished by creating a disinfecting environment. Creating a disinfecting environment may involve any number of steps and implementing components, and creating a disinfecting environment may be accomplished readily by those with ordinary skill in the art from the disclosure herein.

For the exemplary purposes of this disclosure, creating a disinfecting environment may be accomplished by flooding the controlled environment around the animal bedding with one or more gaseous disinfecting mediums. Accordingly, the controlled environment may be flooded with disinfecting gasses including O₃, any other like disinfecting gas, and/or any combination thereof to kill all pathogens in the controlled environment. In creating a disinfecting environment, gaseous disinfecting mediums may be supplied at concentrations of about 4% or more for times of about 5 min. or more.

For example, in FIG. 2, disinfecting horse bedding 16 may be accomplished by covering bedding 16 with cover 22 and using disinfecting system 17 to supply airborne disinfecting medium 30 to the covered bedding 16. Disinfecting system 17 may include cover 22, cover inlet valve 29, airborne disinfecting medium 30, control device 40, tank 42, and sensor 44.

Using cover 22, a substantially sealed, or at least partially sealed, controlled environment may be created around bedding 16 to more effectively and/or efficiently disinfect bedding 16. Gaseous airborne disinfecting medium 30 may then be supplied at concentrations of about 4% or more for a time period of about 5 min. or more from disinfecting medium tank 42 through inlet valve 29 in cover 22 to covered bedding 16 under the coordination and control of control device 40.

Control device 40 may be a user-selectable and/or programmed, air condition power controller. Control device 40 may also include a display (e.g. a dual 4-digit LED display) for set point and air condition indication (e.g. concentration in %, temperature in either ° F. or ° C., and the like). Control device 40 may also comprise a central processing unit that comprises a program with parameter settings that may coordinate and control the components and functions of disinfecting system 17. Control device may also have associated therewith a local data storage device such as a local hard drive, random access memory (RAM), or other magnetic or electronic data storage medium. The local data storage device may be used for any number of data storage functions common to a processor, but is particularly useful for storing data necessary for the operation of disinfecting system 17, such as an operating system and application software. Control device 40 may be powered by any power source known in the art. Examples of conventional power sources include gas, electric, and solar.

Accordingly, control device 40 may be configured to facilitate ventilation control for gaseous airborne disinfecting medium 30. Control device 40 may be coupled (e.g. electrically and/or mechanically) to and may control the activation of tank 42 in conjunction with sensor 44 that may measure concentration. Upon receiving signals from the sensor 44, control device may cause tank 42 to increase or decrease supply of airborne disinfecting medium 30 in proportion to concentration demands.

Sensor 44 is capable of measuring one or more air conditions and transmitting respective stimulus dependent thereon to control device 40. Sensor 44 may be a dual sensor for example or a combination of sensors capable of sensing more than one air condition. Air conditions capable of being measured by sensor 44 and utilized by control device 40 include, but are not limited to: temperature; humidity; moisture content; disinfecting medium concentrations; and/or any combination thereof. For the purposes of this example, sensor 44 may measure airborne disinfecting medium 30 concentration. Sensor 44 may be routed (e.g. a wired, field wired, or wireless) and located anywhere in the controlled environment created by cover 22 and floor 14, even in bedding 16, where air conditions may be accurately sensed. One of ordinary skill in the art will be able to locate sensor 44 in an appropriate location to sense accurate air conditions while taking into account considerations such as the disinfecting method and/or system used, the bedding used, and the like for example. For purposes of this example, sensor 44 may be located in bedding 16 at a predetermined depth.

Control device 40 may use a single sensor differential method for ventilation activation. Using control device 40, a concentration set-point for ventilation activation may be set and stored. Then, during use, control device 40 may cause sensor 44 to sense concentration and to transmit to control device 40 respective concentration stimulus dependent thereon. Upon receiving the stimulus, control device 44 may compare the concentration set-point to the sensed concentration. If the sensed concentration is less than the concentration set-point, control device 40 may activate tank 42 to cause the transport of airborne disinfecting medium 30 to covered bedding 16, thereby increasing concentration and maintaining covered bedding 16 at the concentration set-point.

Alternatively and for the exemplary purposes of this disclosure, creating a disinfecting environment may be accomplished by flooding the controlled environment around the animal bedding with one or more aspirated disinfecting mediums. Accordingly, the controlled environment may be flooded with aspirated disinfecting mediums including aspirated alcohols, aspirated phenolics, aspirated hypochlorites, aspirated quaternary ammonium compounds, aspirated chlorohexidine, aspirated iodophors, aspirated pine oil, any other like aspirated disinfecting medium, and/or any combination thereof to kill all pathogens in the controlled environment. In creating a disinfecting environment, aspirated disinfecting mediums may be supplied at concentrations of about 4% or more for times of about 5 min. or more.

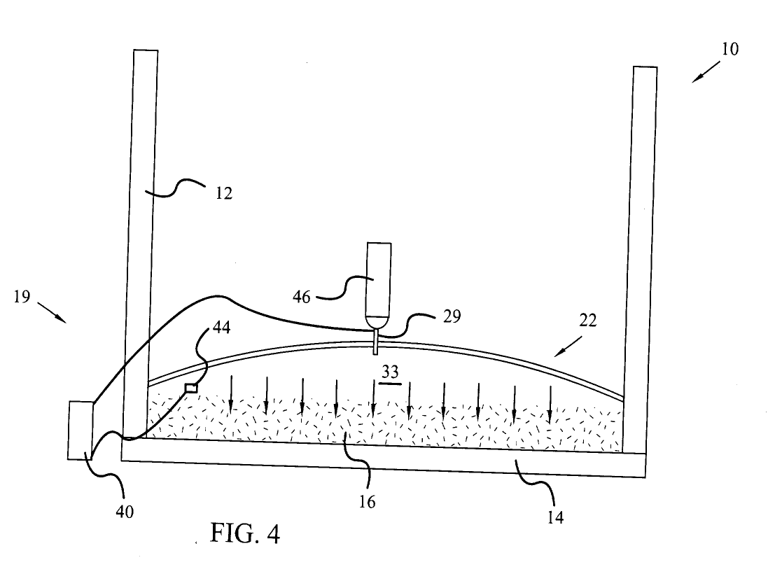

For example, referring to FIG. 4, disinfecting horse bedding 16 may be accomplished by covering bedding 16 with cover 22 and using disinfecting system 19 to supply airborne disinfecting medium 33 to the covered bedding 16. Disinfecting system 19 may include cover 22, cover inlet valve 29, airborne disinfecting medium 33, control device 40, aerosol canister 46, and sensor 44.

Under the coordination and control of control device 40, aspirated airborne disinfecting medium 33 may be supplied to covered bedding 16 from aerosol canister 46 through inlet valve 29 in cover 22. Aspirated airborne disinfecting medium 33 may be supplied at concentrations of about 4% or more for a time period of about 5 min. or more.

Control device 40 may coordinate and control the components and functions of disinfecting system 19, and, accordingly, may be configured to facilitate ventilation control for aspirated airborne disinfecting medium 33. Control device 40 may be coupled (e.g. electrically and/or mechanically) to and may control the activation of aerosol canister 46 in conjunction with sensor 44. Sensor 44 may measure aspirated airborne disinfecting medium 33 concentration and may be located atop bedding 16. Upon receiving signals from sensor 44, control device 40 may cause aerosol canister 46 to increase or decrease supply of airborne disinfecting medium 33 respectively in proportion to concentration demands.

Control device 40 may use a single sensor differential method for ventilation activation. Using control device 40, a concentration set-point for ventilation activation may be set and stored. Then, during use, control device 40 may cause sensor 44 to sense concentration and to transmit to control device 40 respective concentration stimulus dependent thereon. Upon receiving the stimulus, control device 44 may compare the concentration set-point to the sensed concentration. If the sensed concentration is less than the concentration set-point, control device 40 may activate aerosol canister 46 to cause the transport of airborne disinfecting medium 33 to covered bedding 16, thereby increasing concentration and maintaining covered bedding 16 at the concentration set-point.

In a second embodiment, supplying an airborne disinfecting medium to covered animal bedding may be accomplished by alternately switching from an anaerobic environment to an aerobic environment. Creating an anaerobic environment and an aerobic environment may involve any number of steps and implementing components, and creating an anaerobic environment and an aerobic environment may be accomplished readily by those with ordinary skill in the art from the disclosure herein.

For the exemplary purposes of this disclosure, creating an anaerobic environment may be accomplished by flooding the controlled environment around the animal bedding with one or more gasses to form an anaerobic atmosphere. Accordingly, the controlled environment may be flooded with carbon dioxide (CO₂), nitrogen (N₂), any other like gas, and/or any combination thereof to kill all pathogens which require an aerobic atmosphere to survive. Appropriate concentrations may be about 4% or more, and appropriate times may be about 5 min. or more. For the exemplary purposes of this disclosure, creating an aerobic environment may be accomplished by flooding the controlled environment around the animal bedding with one or more gasses to form an aerobic atmosphere. Accordingly, the controlled environment may be flooded with oxygen (O₂), ozone (O₃), any other like gas, and/or any combination thereof to kill all pathogens which require an anaerobic atmosphere to survive. Appropriate concentrations may be about 4% or more, and appropriate times may be about 5 min. or more.

Accordingly and for the exemplary purposes of this disclosure, creating an anaerobic environment and an aerobic environment may comprise a two-stage gas flooding process. In the first stage, the controlled environment around the animal bedding is flooded with one or more gasses selected to kill pathogens which require an anaerobic atmosphere to survive. In the second stage, the controlled environment around the animal bedding is flooded with one or more gasses selected to kill pathogens which require an aerobic atmosphere to survive. Notwithstanding, it will be understood by those of ordinary skill in the art that this sequence of steps could be reversed.

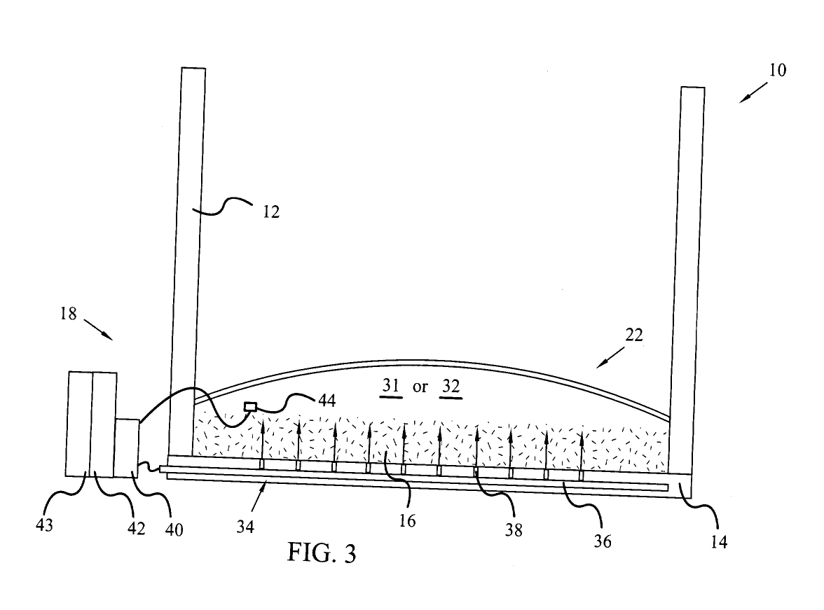

For example, referring to FIG. 3, disinfecting horse bedding 16 may be accomplished by covering bedding 16 with cover 22 and using disinfecting system 18 to supply airborne disinfecting mediums 31 and 32 to the covered bedding 16. Disinfecting system 18 may include cover 22, ventilation system 34, gaseous airborne disinfecting mediums 31 and 32, control device 40, tanks 42 and 43, and sensor 44.

Supplying gaseous airborne disinfecting mediums 31 and 32 to the covered bedding 16 may be a two-stage gas flooding process. In the first stage, under the coordination and control of control device 40 and from disinfecting medium tank 42 through ventilation system 34, the controlled environment around bedding 16 may be flooded with gaseous airborne disinfecting medium 31 selected to kill pathogens which require an aerobic atmosphere to survive at a concentrations of about 4% or more for a time period of about 5 min. or more. In the second stage, under the coordination and control of control device 40 and from disinfecting medium tank 43 through ventilation system 34, the controlled environment around bedding 16 may be flooded with gaseous airborne disinfecting medium 32 selected to kill pathogens which require an anaerobic atmosphere to survive at a concentration of about 4% or more for a time period of about 5 min. or more.

Ventilation system 34 may be buried in or built into floor 14, depending upon the type of floor 14. Ventilation system 34 may comprise inlet tube 36 coupled (e.g. electrically and/or mechanically-fluidly) to control device 40 and tanks 42 and 43. Coupled (e.g. mechanically-fluidly) along inlet tube 36 in a series may be the proximal end portions of outlet tubes 38, the distal end portions of which open to the upper surface of floor 14. Notwithstanding, for the exemplary purposes of this disclosure, the stall floor vent systems as disclosed in the co-pending patent application to William Opfel entitled “VENTING SYSTEM FOR ANIMAL STALL,” Ser. No. ______, filed ______, the disclosure of which is hereby incorporated herein by reference and summarized by the following explanation, are examples of ventilation systems that may be useful.

Accordingly, embodiments of stall floor venting systems for animal stalls include a venting layer and an animal bedding layer. Particular embodiments also include a separation layer and/or a diffusion layer. In one embodiment of the invention, a stall floor comprises a ventilation layer and a bedding layer. A pumping system pumps one or more gases (such as air) either into or out of the ventilation layer. The ventilation layer comprises a network of passages which release gas to or draw gas from the bedding layer. By gas passing through the bedding layer, the bedding layer dries more quickly. In other particular embodiments, the ventilation layer may further comprise a diffusion layer and/or a separation layer. The diffusion layer, if used, disperses the flow of the gasses through the bedding layer so that the gasses pass by more surface area of the bedding. The separation layer, if used, maintains a separation between the bedding layer and lower-lying layers. The ventilation layer may be as simple as a network of perforated pipes running in parallel rows below the bedding layer, may include porous mats having passageways thereunder or there through for distributing the gasses, may include a geotextile vent layer, or may include more complex composite concrete-like porous flexible synthetic and aggregate mixtures through which the gasses pass or geotextile air venting systems.

Control device 40 may coordinate and control the components and functions of disinfecting system 18, and, accordingly, may be configured to facilitate ventilation control for gaseous airborne disinfecting mediums 31 and 32. Control device 40 may be coupled (e.g. electrically and/or mechanically) to and may control the activation of tanks 42 and 43 in conjunction with sensor 44. Sensor 44 may measure both airborne disinfecting medium 31 and 32 concentration, and sensor 44 may be located atop bedding 16. Upon receiving signals from sensor 44, control device 40 may cause tanks 42 or 43 to increase or decrease supply of gaseous airborne disinfecting medium 31 or 32 respectively in proportion to concentration demands.

Control device 40 may use a single sensor differential method for ventilation activation. Using control device 40, concentration set-points for ventilation activation may be set and stored. Then, during use, control device 40 may cause sensor 44 to sense concentrations and to transmit to control device 40 respective concentration stimulus dependent thereon. Upon receiving the stimuli, control device 44 may compare the concentration set-points to applicable sensed concentrations. If the sensed concentrations are less than the concentration set-points, control device 40 may activate tanks 42 or 43 to cause the transport of gaseous airborne disinfecting medium 31 or 32 respectively to covered bedding 16, thereby increasing concentrations and maintaining covered bedding 16 at the concentration set-points.

In a third embodiment, supplying an airborne disinfecting medium to covered animal bedding may be accomplished by creating a sterilizing environment around the soiled animal bedding. Creating a sterilizing environment may involve any number of steps and implementing components, and creating a sterilizing environment may be accomplished readily by those with ordinary skill in the art from the disclosure herein.

For the exemplary purposes of this disclosure, creating a sterilizing environment may be accomplished by steam sterilizing the animal bedding by applying a moist heat. Steam is an effective disinfectant, killing pathogens particularly when contaminants have been previously removed with a detergent, for example. For steam sterilizing, appropriate temperatures may be about 100-200° F. or more, appropriate times may be about 5 min. or more, such as about 60 minutes, and appropriate pressures may be about atmospheric pressure or more.

Accordingly, if the animal bedding is in situ, steam sterilizing the animal bedding may be accomplished by flooding the controlled environment around the animal bedding with saturated steam to kill all pathogens in the controlled environment. Alternatively, if the animal bedding is removed from the stall, steam sterilizing the animal bedding may accomplished in one or more autoclaves and by flooding the controlled environment around the animal bedding using both elevated pressures, such as from about atmospheric pressure to about 100 psi or more, and saturated steam to kill all pathogens in the controlled environment.

Additionally and for the exemplary purposes of this disclosure, after steam sterilizing the animal bedding in situ or out of the stall, it may be necessary to dry the animal bedding. Drying the sterilized animal bedding may be accomplished by simple evaporation with sterilized animal bedding left in situ or placed (e.g. transported by conveyor) in an evaporating stock pile, or by drying in a rotating kiln dryer. Time for evaporation will depend upon many considerations, such as the animal bedding, the rinse used, the size of the pile or stall, and the like, among other considerations. For example, several days to a week may be required for the entire stall of animal bedding to dry or stockpile to dry, or several minutes may only be required for the bedding to dry in a rotary kiln. In the case of alcohol rinsed animal bedding, several hours to a day may only be required for the entire stall of animal bedding to dry or stock pile to dry. Notwithstanding, granular clay compositions like Equidry™ as discussed previously are particularly advantageous in that they can dry within only hours due to their high surface areas. For example, Equidry™, when used with appropriate ventilation in a 12′×12′ stall, may dissipate up to 200 gallons within 4 hours to no noticeable moisture and within 12 hours to no measurable moisture.

Alternatively and for the exemplary purposes of this disclosure, after steam sterilizing the animal bedding in situ or out of the stall, drying the sterilized animal bedding may be accomplished by dry-heating. Dry-heating animal bedding in situ may be accomplished by covering the sterilized animal bedding with a heating/reflective cover combination or other similar cover to create at least partially sealed controlled environment around the animal bedding to more effectively and/or efficiently dry the sterilized animal bedding. Accordingly, for example, in order to vent moisture/steam that may be generated during drying, the cover may be perforated or include an open air valve, or a corner of the cover may be left open or unsealed. Specific exposures may be dictated by the animal bedding among other considerations, with higher temperatures requiring less exposure time. Using heat generated from the cover, animal bedding may then be dried at a temperature of approximately 100° F. to approximately 2,000° F. for a time period of approximately 5-60 minutes or more. In addition, dry-heating animal bedding in situ may be accomplished with a flame, such as a portable, gas-powered (e.g. propane) burner or torch system. The flame may be under a hood or other cover as previously described for example. Heating the animal bedding with a flame may be carried out at a temperature of approximately 100° F. to approximately 2,000° F. for a time period of approximately 5-60 minutes.

Out of the stall, dry-heating may occur in stages and may be accomplished using gas, diesel, electric, infrared, and other drying and heating devices. For example, drying and heating devices may include conveyorized ovens, tunnel ovens, batch ovens, gas fired ovens, electric ovens, aging ovens, process ovens, infrared ovens, low temp ovens, high temp ovens, heat treating ovens, drying ovens, air dryers, flotation dryers, hot air impingement dryers, rotary dryers/kilns, electric furnaces, high temperature furnaces, heat treating furnaces, gas fired crucible furnaces, electric crucible furnaces, reverbatory furnaces, other similar drying devices as known in the art, and/or any combination thereof. For example, animal bedding granules to be dried may be introduced into a conveyorized oven. Drying in a conveyorized drying oven may be carried out at a temperature of approximately 100° F. to approximately 2,000° F. for a time period of approximately 5-60 minutes.

In another embodiment of the invention, disinfecting soiled animal bedding according to step 104 may be accomplished by rinsing the soiled animal bedding and drying the rinsed animal bedding. Rinsing soiled animal bedding and drying rinsed animal bedding may involve any number of steps and implementing components, and rinsing soiled animal bedding and drying rinsed animal bedding may be accomplished readily by those with ordinary skill in the art from the disclosure herein. Appropriate disinfecting mediums may be any of those described previously, such as hot water, steam, ozonated water, alcohols, phenolics, hypochlorites, quaternary ammonium compounds, chlorohexidine, iodophors, pine oil, and the like. If necessary, any disinfecting medium may be diluted.

For the exemplary purposes of this disclosure, rinsing soiled animal bedding in situ may be accomplished by any applicator that is configured to apply any disinfecting medium to soiled animal bedding. For example, an applicator may be any sprayer, a steam cleaner, in ground ventilation systems, any other similar applicator as known in the art, and/or any combination thereof. For example, the walls of the stall (begin at the top) and the animal bedding may be sprayed with hot water, steam, ozonated water, alcohols, phenolics, hypochlorites, quaternary ammonium compounds, chlorohexidines, iodophors, pine oils, and the like using a sprayer or steam cleaner as the case may be. Depending upon the disinfecting medium used, appropriate concentrations may be about 4% or more, and appropriate times may be about 5 min. or more.

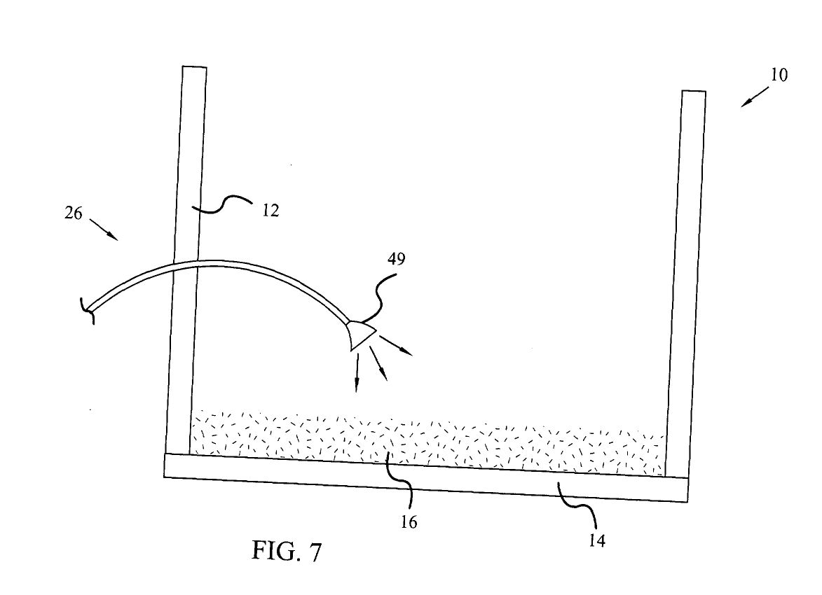

As another example, referring to FIG. 7, disinfecting horse bedding 16 may be accomplished by using disinfecting system 26 to supply a disinfecting medium to the covered bedding 16. Disinfecting system 26 may include a garden hose, a disinfecting medium as described previously, and sprayer 49. Sprayer 49 may be any hose end sprayer having any number of features and advantages. For example, sprayer 49 may operate in the normal range of home water pressure and may spray concentrated disinfecting mediums. Sprayer 49 may be configured to siphon concentrated disinfecting mediums from a reservoir, mix the concentrated disinfecting mediums properly with water in a sprayer head, and produce a uniform spray pattern to apply a diluted disinfecting medium onto horse bedding 16 at a concentration of approximately 4% or more. Sprayer 49 may not only apply thin liquid disinfecting medium spray concentrates, but may also apply thick liquids or wettable powders with appropriate measuring and premixing. Sprayer 49 may also have a swivel hose-connector to easily connect the garden hose, an anti-siphon valve to prevents chemicals from being siphoned into the water system, an ON/OFF control, an adjustable deflector nozzle to spray up or down, a large dial with different mix settings plus OFF to spray water only, and screens in the hose connector and siphoning tube to prevent clogging.

For the exemplary purposes of this disclosure, rinsing soiled animal bedding out of the stall may be accomplished by immersing the soiled animal bedding into a disinfecting medium bath until the bedding is disinfected. For example, an immersion bath may be any bath, boiling bath, unstirred bath, stirred bath, circulating bath, heating bath, high temperature bath, shaking bath, dual-action shaking bath, reciprocating shaking bath, linear shaking bath, orbital shaking bath, ultrasonic bath, rotary bath, any other similar bath as is known in the art, and/or any combination thereof. Depending upon the disinfecting medium used, appropriate concentrations may be about 4% or more, appropriate temperatures may be about 100-200° F. or more, and appropriate times may be about 5 min. or more.

Additionally and for the exemplary purposes of this disclosure, rinsing soiled animal bedding out of the stall may be accomplished by washing soiled animal bedding with a disinfecting medium on one or more wet vibrating screens equipped with high pressure wash nozzles that create a spray bath. On one or more wet vibrating screens, there is a reduced possibility of animal bedding granules insulating other granules from rinsing as granules are continuously vibrating on the screens so that they come in contact with the disinfecting medium wash multiple times per minute.

For the exemplary purposes of this disclosure, drying rinsed animal bedding in situ may be accomplished by covering rinsed animal bedding with a heating/reflective cover combination or other similar cover to create at least partially sealed controlled environment around the animal bedding to more effectively and/or efficiently dry the rinsed animal bedding. Accordingly, for example, in order to vent moisture/steam that may be generated during drying, the cover may be perforated or include an open air valve, or a comer of the cover may be left open and unsealed. Specific exposures may be dictated by the animal bedding and the rinse used among other considerations, with higher temperatures requiring less exposure time. Using heat generated from the cover, animal bedding may then be dried at a temperature of approximately 100° F. to approximately 2,000° F. for a time period of approximately 5-60 minutes or more. Alternatively and for the exemplary purposes of this disclosure, drying rinsed animal bedding in situ may also be accomplished by evaporation as previously explained.

For the exemplary purposes of this disclosure, drying rinsed animal bedding out of the stall may be accomplished by dry-heating. Dry-heating may occur in stages and may be accomplished using gas, diesel, electric, infrared, and other drying and heating devices as previously explained. Specific exposures may be dictated by the animal bedding and the contaminants and the pathogens presented among other considerations, with higher temperatures requiring less exposure time. For example, animal bedding granules to be dried may be introduced into a conveyorized drying oven and may be dried at a temperature of approximately 100° F. to approximately 2,000° F. for a time period of approximately 5-60 minutes. Alternatively, and for the exemplary purposes of this disclosure, drying rinsed animal bedding out of the stall may be accomplished by evaporation as previously explained.

In another embodiment of the invention, disinfecting soiled animal bedding according to step 104 may be accomplished by heating the soiled animal bedding. Heating soiled animal bedding may involve any number of steps and implementing components, and heating soiled animal bedding may be accomplished readily by those with ordinary skill in the art from the disclosure herein. Specific exposures may be dictated by the animal bedding and the contaminants and the pathogens presented among other considerations, with higher temperatures requiring less exposure time.

For the exemplary purposes of this disclosure, the animal bedding may be removed from the stall and heated. Heating the animal bedding out of the stall may be accomplished by kilning for example. Kilning may involve any number of steps and implementing components, and kilning soiled animal bedding may be accomplished readily by those with ordinary skill in the art from the disclosure herein. In addition, kilning may occur in stages and may be accomplished using a propane-fired, stainless steel, rotary kiln or other kilns as known in the art. Furthermore, kilning may comprise either flash kilning or long term kilning, and kilning techniques are well known to those of ordinary skill in the art.

Accordingly, animal bedding granules to be fired may be introduced into a propane-fired, stainless steel, rotary kiln. In a rotary kiln, there is a reduced possibility of granules insulating other granules from firing as granules are continuously rolling in the rotating kiln tube so that they come in contact with the flame multiple times per minute. If granules are left in the kiln for too long or at too high a temperature, the clay may vitrify completely or melt into a glass-like material and be of no use as an absorbent. Flash kilning may be carried out at a temperature of approximately 100° F. to approximately 2,000° F. for a time period of approximately 5-60 minutes.

Heating the animal bedding out of the stall may also be accomplished by dry-heat sterilization in which a dry heat is applied to the animal bedding. Dry-heat sterilization may involve any number of steps and implementing components, and dry-heat sterilization may be accomplished readily by those with ordinary skill in the art from the disclosure herein.

Accordingly, dry-heat sterilization may occur in stages and may be accomplished using gas, diesel, electric, infrared, and other drying and heating devices as previously explained. For example, animal bedding granules to be heated may be introduced into a conveyorized oven. Heating in a conveyorized oven may be carried out at a temperature of approximately 100° F. to approximately 2,000° F. for a time period of approximately 5-60 minutes.

Alternatively and for the exemplary purposes of this disclosure, the animal bedding may be heated in place on the stall floor. Heating animal bedding in situ may involve any number of steps and implementing components, and heating may be accomplished readily by those with ordinary skill in the art from the disclosure herein. For example, heating animal bedding in situ may be accomplished with a flame, such as a portable, gas-powered (e.g. propane) burner or torch system. The flame may be under a hood or other cover as previously described for example. Heating the animal bedding with a flame may be carried out at a temperature of approximately 100° F. to approximately 2,000° F. for a time period of approximately 5-60 minutes. Alternatively, and for example, heating the animal bedding in situ may be accomplished by dry-heat sterilization in which a dry heat is applied to the animal bedding. Heating animal bedding in situ may be accomplished by covering soiled animal bedding with a heating/reflective cover combination or other similar cover to create at least partially sealed controlled environment around the animal bedding to more effectively and/or efficiently heat the soiled animal bedding. Accordingly, for example, in order to vent moisture/steam that may be generated during heating, the cover may be perforated or include an open air valve, or a comer of the cover may be left open and unsealed. Using heat generated from the cover, animal bedding to be sterilized may be heated to a temperature of about 200° F. to approximately 2,000° F. for a time period of approximately 5-30 minutes.

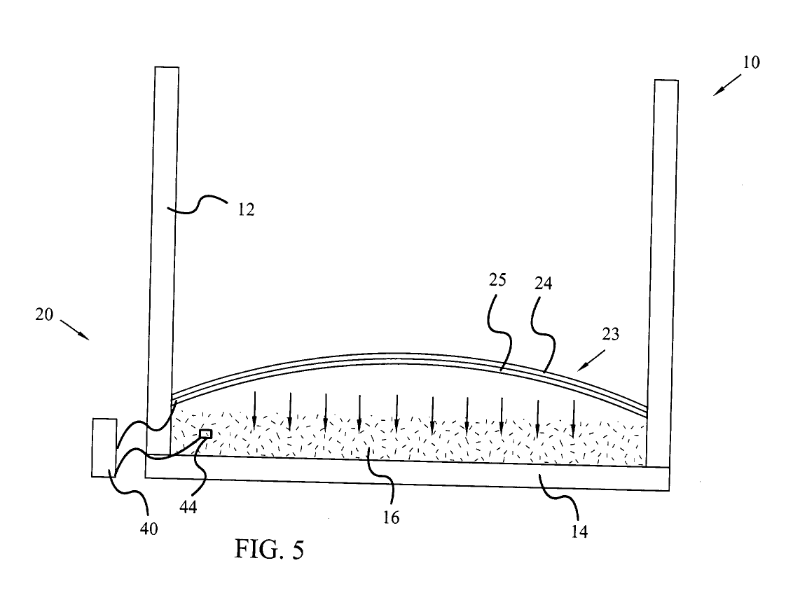

For example, turning to FIG. 5, disinfecting bedding 16 may be accomplished by covering bedding 16 with cover 23 and using disinfecting system 20 to supply dry-heat sterilization to the covered bedding 16. Disinfecting system 20 may include cover 23, control device 40, and sensor 44.

Cover 23 may comprise temperature-resistant, reflective cover 24 and heating cover 25. Although cover 24 and cover 25 are illustrated as adjacent or coupled to one another, cover 24 and cover 25 may be integrally joined together to comprise a heating/reflective cover for example. Heating cover 25 may have electrical heating coils disposed therein to generate heat, and under the coordination and control of control device 40, heating cover 25 may supply heat to covered bedding 16 so it may be heated to a temperature of about 200° F. to approximately 300° F. for a time period of approximately 5-60 minutes.

Control device 40 may coordinate and control the components and functions of disinfecting system 20, and, accordingly, may be configured to facilitate temperature control for cover 23. Control device 40 may be coupled (e.g. electrically and/or mechanically) to and may control the activation of cover 23 in conjunction with sensor 44. Sensor 44 may measure bedding temperature, and sensor 44 may be located within bedding 16. Upon receiving signals from sensor 44, control device 40 may cause cover 23 to increase or decrease supply of heat respectively in proportion to temperature demands.

Control device 40 may use a single sensor differential method for ventilation activation. Using control device 40, a temperature set-point for heating activation may be set and stored. Then, during use, control device 40 may cause sensor 44 to sense temperature and to transmit to control device 40 respective temperature stimulus dependent thereon. Upon receiving the stimulus, control device 44 may compare the temperature set-point to the sensed temperature. If the sensed temperature is less than the temperature set-point, control device 40 may activate cover 23 to cause the transport of heat to covered bedding 16, thereby increasing temperature and maintaining covered bedding 16 at the temperature set-point.

In another embodiment of the invention, disinfecting soiled animal bedding according to step 104 may be accomplished by irradiating the soiled animal bedding. Irradiating soiled animal bedding may involve any number of steps and implementing components, and irradiating soiled animal bedding may be accomplished readily by those with ordinary skill in the art from the disclosure herein.

Accordingly and for the exemplary purposes of this disclosure, irradiating soiled animal bedding may be accomplished simultaneously with preparing soiled animal bedding according to step 102 as previously described. Accordingly, for example, one or more ultraviolet light, microwave, gamma radiation, and/or the like sources may be directed at a stream of animal bedding at some point within a cleaning system according to an embodiment of the invention as previously described to destroy pathogens exposed to the ultraviolet, microwave, gamma, and/or the like energy. The irradiation sources may also be included within a shroud or hood feature to destroy pathogens on and among the animal bedding within the shroud. By placing the irradiation sources within the shroud, and perhaps by even including direction and protection plates, the exposure regions for energy may be limited to specific regions within the shroud. A coating may optionally be placed on the inner surface of the shroud or on portions of the lights to absorb ultraviolet energy contacting the surface to prevent reflection to areas outside the shroud or to direct the energy emitting from the irradiation sources.

For example, ultraviolet light sources are currently available, for example, from Atlantic Ultraviolet Corporation of Hauppauge, N.Y. for use in air duct disinfecting systems, and may readily be adapted by one of ordinary skill in the art for use with embodiments of the present invention. Atlantic Ultraviolet Corporation has found that by emitting ultraviolet energy toward a surface, a large majority of the energy having a wavelength which is at the mercury resonance line of 254 nanometers, germs such as virus, bacteria and mold spores can be destroyed with as high as 98% effectiveness.

Notwithstanding and also for the exemplary purposes of this disclosure, irradiating soiled animal bedding may also be accomplished separately from preparing soiled animal bedding according to step 102 as previously described. Accordingly, for example, one or more ultraviolet light, microwave, gamma radiation, and/or the like sources may be directed at animal bedding in situ to destroy pathogens exposed to the ultraviolet, microwave, gamma, and/or the like energy over a period of time. Notwithstanding, one or more ultraviolet light, microwave, gamma radiation, and/or the like sources may also be directed at animal bedding removed from the stall as well. In either case, the irradiation sources individually or collectively may also be included within a cover such as a tarp, a shroud, a hood, or the like to destroy pathogens on and among the animal bedding within the cover. By placing the irradiation sources within a cover, the exposure region for energy may be limited to the specific region within the shroud (e.g. just the stall floor). A coating may optionally be placed on the inner surface of the cover or on portions of the irradiation sources to absorb energy contacting the surface to prevent reflection to areas outside the cover or to direct the energy emitting from the irradiation sources.

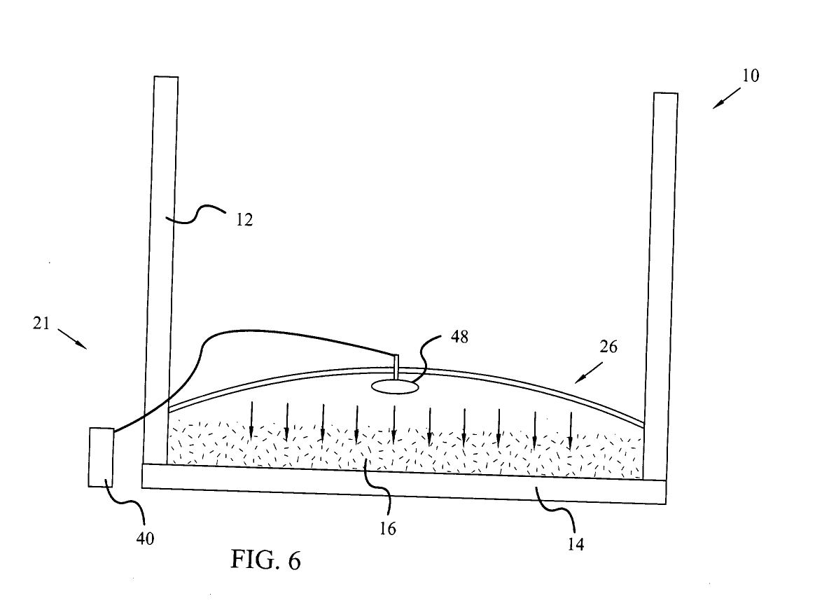

For example and as depicted in FIG. 6, disinfecting bedding 16 may be accomplished by covering bedding 16 with cover 26 and using disinfecting system 21 to irradiate covered bedding 16. Disinfecting system 21 may include cover 26, at least one UV light, microwave, gamma radiation, and/or the like irradiation source 48, control device 40, and sensor 44. Cover 26 may be similar to cover 22, but more sturdy to support irradiation source 48, and/or cover 26 may comprise a coating placed on the inner surface of cover 26 or on portions thereof to absorb energy contacting the inner surface to prevent reflection to areas outside cover 26.

Control device 40 may coordinate and control the components and functions of disinfecting system 21, and, accordingly, may be configured to facilitate energy control for irradiation source 48. Control device 40 may be coupled (e.g. electrically and/or mechanically) to and may control the activation of irradiation source 48.

Turning back to FIG. 1, step 106 of method 100 is to reuse the disinfected animal bedding. Reusing the disinfected animal bedding in step 106 may involve any number of steps and implementing components, and reusing the disinfected animal bedding may be accomplished readily by those with ordinary skill in the art from the disclosure herein.

For the exemplary purposes of this disclosure, if the bedding was removed from a stall originally, the disinfected animal bedding may be returned to the area from which it was removed, may be stored for a time to allow for additional cleaning of the area before the animal bedding is returned, or may be returned to a different area from that which it was removed. Thus, for example, the disinfected bedding may be replaced back on the floor of the same or other animal stall(s) to a depth of approximately ½ inch to 8 inches or more for example in preparation for re-introducing the animal(s) to the particular stall(s). The animal bedding may be easily maintained in a like new condition by removing fines introduced by the animal's waste breakdown and environment with a cleaning system as previously described so that the bedding may remain in place for extended periods of time, such as at least six to twelve months, if not longer, for example, or until the bedding is disinfected again.

Accordingly, it is contemplated that embodiments of the invention may be used to disinfect animal bedding for use within the region from which the bedding originated, or for use in a different region. An embodiment of the invention may be configured with a large container or truck bed for storing and transporting cleaned animal bedding for use elsewhere. It is also contemplated that soiled animal bedding may be dropped-off by an animal owner or otherwise transported to a central location and then cleaned in bulk at that location for later re-use. There are many ways that animal bedding may be re-used or otherwise recycled for use as animal bedding or for other uses through embodiments of the present invention.

In describing the use of the present invention further, the following examples illustrate some particular embodiments of disinfecting systems and methods of the present invention in a horse stall environment. In general, and as depicted in FIGS. 2-7, horse stall 10 illustrates the major features of a typical horse stall. Accordingly, horse stall 10 may be approximately a 12′ by 14′ by 8′ horse stall for example and may comprise side walls 12 and floor 14. Side walls 12 may be comprised of varnished wood panels, metal, aluminum, or mesh panels, painted concrete blocks, or other sidewall materials. Floor 14 may be comprised of the ground or some other flooring, such as concrete, mats of geotextiles, wood planks, or other flooring materials. Placed on floor 14 to a depth of approximately 2 inches to 5 inches is horse bedding 16. For the exemplary purposes of this disclosure and the following examples, stall 10 is comprised of side walls 12 of painted concrete blocks, floor 14 of concrete, and horse bedding 16 of Equidry™ granular clay horse bedding as previously described. Notwithstanding, those of ordinary skill in the art will be able to apply these examples to other litters, stalls, and the like from the disclosure provided herein. Moreover, although specific implementing components are disclosed in the following examples, it will be understood by those of ordinary skill in the art that other implementing components as described previously may be utilized.

### EXAMPLE 1

Turning to FIG. 2, assuming Equidry™ horse bedding 16 has been soiled and comprises contaminants and pathogens, disinfecting Equidry™ horse bedding 16 in stall 10 begins with cleaning Equidry™ horse bedding 16 with any of the vacuum and/or blower cleaning systems as a previously described to remove contaminants from Equidry™ bedding 16. Disinfecting Equidry™ bedding 16 is then accomplished by covering Equidry™ bedding 16 with cover 22 (i.e. tarp) and using disinfecting system 17 to supply airborne disinfecting medium 30 (i.e. ozone gas) to covered Equidry™ bedding 16. Taping the edges of tarp 22 to block walls 12, a substantially sealed controlled environment is created around the inside perimeter of stall 10, thereby trapping Equidry™ bedding 16 between tarp 22 and concrete floor 14. Under the direction and control of control device 40 and in conjunction with sensor 44, ozone gas 30 is then supplied at a concentration of 4% for a time period of 5 min. from tank 42 through inlet valve 29 in tarp 22 to covered Equidry™ bedding 16. Upon receiving signals from sensor 44, control device causes tank 42 to increase or decrease supply of ozone gas 30 in proportion to ozone concentration demands.

Once disinfected, Equidry™ horse bedding 16 may be reused on concrete floor 14 of stall 10 in preparation for re-introducing the horse to stall 10. Equidry™ bedding 16 is easily maintained to a like new condition by removing fines introduced by the horse's waste breakdown with a cleaning system as previously described so that the bedding may remain in place for extended periods of time, such as at least six to twelve months, if not longer, for example, or until Equidry™ horse bedding 16 is disinfected again.

### EXAMPLE 2

Referring to FIG. 3, assuming Equidry™ horse bedding 16 has been cleaned to remove contaminants, including organic matter, as described in Example 1 for instance, disinfecting Equidry™ bedding 16 is accomplished by covering Equidry™ bedding 16 with tarp 22 and using disinfecting system 18 to supply airborne disinfecting mediums 31 (i.e. nitrogen gas) and 32 (i.e. ozone gas) to covered Equidry™ bedding 16. Taping the edges of tarp 22 to block walls 12, a substantially sealed controlled environment is created around the inside perimeter of stall 10, thereby trapping Equidry™ bedding 16 between tarp 22 and concrete floor 14. Under the direction and control of control device 40 and in conjunction with sensor 44, nitrogen gas 31 is first supplied at a concentration of 4% for a time period of 5 min. from tank 42 through ventilation system 34 buried in concrete floor 14 to covered Equidry™ bedding 16 to kill pathogens which require an aerobic atmosphere to survive, and then ozone gas 30 is supplied at a concentration of 4% for a time period of 5 min. from tank 43 through ventilation system 34 to covered Equidry™ bedding 16 to kill pathogens which require an anaerobic atmosphere to survive. Upon receiving signals from sensor 44, control device 40 causes tank 42 or 43 to increase or decrease supply of nitrogen gas 31 or ozone gas 32 respectively in proportion to concentration demands. Once disinfected, Equidry™ horse bedding 16 may be reused as described in Example 1.

### EXAMPLE 3

Referring to FIG. 4, assuming Equidry™ horse bedding 16 has been cleaned to remove contaminants, including organic matter, as described in Example 1 for instance, disinfecting Equidry™ bedding 16 is accomplished by covering Equidry™ bedding 16 with tarp 22 and using disinfecting system 19 to supply aspirated disinfecting medium 33 (i.e. Lysol®) to covered Equidry™ bedding 16. Taping the edges of tarp 22 to block walls 12, a substantially sealed controlled environment is created around the inside perimeter of stall 10, thereby trapping Equidry™ bedding 16 between tarp 22 and concrete floor 14. Under the direction and control of control device 40 and in conjunction with sensor 44, Lysol® 33 is supplied at a concentration of 4% for a time period of 5 min. from aerosol canister 46 through inlet valve 29 in tarp 22 to covered Equidry™ bedding 16. Upon receiving signals from sensor 44, control device 40 causes aerosol canister 46 to increase or decrease supply of Lysol® 33 in proportion to concentration demands. Once disinfected, Equidry™ horse bedding 16 may be reused as described in Example 1.

### EXAMPLE 4

Referring to FIG. 5, assuming Equidry™ horse bedding 16 has been cleaned to remove contaminants, including organic matter, as described in Example 1 for instance, disinfecting Equidry™ bedding 16 is accomplished by covering Equidry™ bedding 16 with cover 23 (i.e. heating/reflective cover) and using disinfecting system 20 to supply dry-heat sterilization to covered Equidry™ bedding 16. Taping the edges of heating/reflective cover 23 to block walls 12, a substantially sealed controlled environment is created around the inside perimeter of stall 10, thereby trapping Equidry™ bedding 16 between heating/reflective cover 23 and concrete floor 14. Under the direction and control of control device 40 and in conjunction with sensor 44, heat is supplied from heating coils in heating/reflective cover 23 at a temperature of 250° F. for a time period of 60 min. to covered Equidry™ bedding 16. Upon receiving signals from sensor 44, control device 40 causes cover 23 to increase or decrease its supply of heat in proportion to temperature demands. Once disinfected, Equidry™ horse bedding 16 may be reused as described in Example 1.

### EXAMPLE 5

Referring to FIG. 6, assuming Equidry™ horse bedding 16 has been cleaned to remove contaminants, including organic matter, as described in Example 1 for instance, disinfecting Equidry™ bedding 16 is accomplished by covering Equidry™ bedding 16 with cover 26 (i.e. a sturdy hood) to create a substantially sealed controlled environment around the inside perimeter of stall 10, thereby trapping Equidry™ bedding 16 between hood 26 and concrete floor 14, and then using disinfecting system 21 to irradiate covered Equidry™ bedding 16. Under the direction and control of control device 40 and in conjunction with sensor 44, irradiation source 48 of disinfecting system 21 supplies ultraviolet, microwave, gamma, and/or the like energy to Equidry™ bedding 16 for a time period of approximately 5 minutes. Once disinfected, Equidry™ horse bedding 16 may be reused as described in Example 1.

### EXAMPLE 6

Turning to FIG. 7, assuming Equidry™ horse bedding 16 has been cleaned to remove contaminants, including organic matter, as described in Example 1 for instance, disinfecting Equidry™ bedding 16 is accomplished by using disinfecting system 26 to spray rinse Equidry™ bedding 16 with the common veterinary chlorhexidine diacetate disinfectant Nolvasan®. Sprayer 49 attached to a garden house siphons concentrated Nolvasan® from its reservoir, mixes the concentrated Nolvasan® with water in a sprayer head, and produces a uniform spray pattern that applies diluted Nolvasan® onto Equidry™ bedding 16 at a concentration of 4%. Once disinfected and dried by evaporation, Equidry™ horse bedding 16 may be reused as described in Example 1.

### EXAMPLE 7

### Coliform Counts in a Long-Term Bedding Material Over Time

Abstract

In a preliminary study, a granular clay product developed for use as a long-term stall bedding for horses (Equidry™, Equidry Bedding Products, Arizona) was sampled and cultured for coliform bacteria to determine whether disinfection is necessary to maintain hygienic conditions and, if so, whether readily available disinfectants are sufficient. Samples cultured prior to installation in test stalls yielded no growth. Samples taken from stalls that were occupied by horses 12 hours per day over a 6-month period, cleaned every 24 hours with a manure fork but without removing wet (urine) spots or organic fines (dust, hay fragments, and manure fragments that fell through the tines of the manure fork), then allowed to “rest” for 12 days prior to sampling, consistently yielded no coliforms. Initially clean samples contaminated in the laboratory with fresh manure and water and allowed to “steep” for 24 hours, then picked with a fork to remove the larger fragments of manure, and cultured immediately, yielded over one million colony-forming units (cfu) of coliforms per gram of soiled bedding. When allowed to air-dry 48 hours before culturing, the coliform count dropped by over 98%. When air-dried samples were further treated with a common veterinary chlorhexidine diacetate disinfectant (Nolvasan® Solution, Fort Dodge Animal Health; Fort Dodge, Iowa 50501) or a common household phenolic disinfectant (Lysol® Concentrate, Household Products Div., Reckett & Colman Inc. Montvale, N.J. 07645), the coliform count dropped by another 98%. Results supported the hypothesis that the high surface area of the bedding material, which supports rapid evaporation of water, contributes to maintenance of hygienic conditions due to desiccation of pathogens, and that the application of common disinfectants may be of benefit.

Introduction

According to the USDA's National Animal Health Monitoring System (NAHMS), in which 2,904 operations keeping one or more equids were surveyed, 67.5% kept equids in bedded stalls, and the most commonly used bedding was straw or hay (45.4%), followed by wood shavings (30.9%). There are several motivating factors to finding alternative bedding for horses. Hygienic conditions conducive to equine respiratory and gastrointestinal health require minimizing exposure to respiratory irritants such as dust and ammonia fumes, and coliform pathogens such as Salmonella and E. coli. Ammonia fumes are implicit with any bedding material that absorbs urine and holds it in the environment, serving as a reservoir for ammonia emissions. Less absorbent materials that allow urine to pool on the stall floor similarly contribute to respirable ammonia levels. Plant-based beddings such as straw and hay, and wood-based beddings such as sawdust and shavings, may contain dust, toxins, and pathogens before use in the stable, in part due to harvest and storage conditions, and in part due to the nature of the material. For example, wood dust from cedar contains the toxin plicatic acid, and pine dust contains albeitic acid, both of which have been associated with inflammatory and allergic conditions such as asthma, rhinitis, and conjunctivitis in human sawmill workers, and in laboratory animals housed on wood shavings. Occupational asthma has been reported to occur in 50% of humans working in wood, paper, and pulp mills. In a German study, workers exposed to pine dust had a threefold increase in risk of glottal cancer. It is well known that most horses diagnosed with chronic obstructive pulmonary disease show a marked decrease in respiratory signs when removed from the stall environment and turned out to pasture.

Removing soaked and soiled bedding materials and manure from the stable helps to decrease respirable ammonia as well as accumulated coliform pathogens, but it is a labor-intensive daily task that results in a rapidly growing pile of soiled and urine-soaked bedding and manure that is relatively slow to decompose through composting. Management may dictate that the pile be hauled away rather than remain on the premises to contribute to air pollution, contamination of water tables through seepage, and attraction of pest insects. Frequent bedding changes add to the problem of disposal and are not likely to improve stall hygiene unless the bedding is hygienic to begin with. The diminishing availability of the most commonly used bedding materials due to their increasingly common use in the construction industry provides more incentive to seek alternative beddings.

A bedding that is basically inert, into which a manure fork easily plunges, which absorbs urine quickly and has sufficient surface area and other properties to encourage rapid evaporation, rather than holding, of water, and which maintains loft, comfort, and hygienic conditions under long-term use, would seem to be the ideal, significantly reducing ammonia emissions, producing manure-only for the compost pile (rather than manure plus a high-cellulose, low-nitrogen bedding material that slows degradation and lowers composting temperature), reducing attraction of pest insects, and eliminating the consumption of construction materials as well as the need for storage of replacement bedding. However, because long-lived bedding is not regularly replaced as are conventional beddings, horse owners and veterinarians may be concerned whether it is hygienic over time relative to bacterial pathogens from contamination by manure, either by the bactericidal effect of desiccation or by periodic disinfection.

The present study was done to test the hypothesis that a natural clay equine stall bedding product (Equidry™), kilned to a hardness that will not break down under use, invested with pores that provide a high surface area for evaporation of absorbed liquid for reduced ammonia emissions, can be maintained in a hygienic state by virtue of desiccation of coliform bacteria, and that further disinfection can be achieved through the use of readily available veterinary and/or household disinfectants.

Materials and Methods

Fifteen gallons of a natural clay equine stall bedding product (Equidry™) were set aside in clean, covered buckets. A semi-truckload of the same bedding was distributed into three indoor stalls, 12 feet×14 feet, bedded 4 inches deep.

Experiment 1. A draft horse was put into each of the indoor stalls for 12 hours each night, then turned out to pasture each day. Urine spots were ignored. Manure was removed with a manure fork/basket every 24 hours. After 6 months of use, the stalls were vacated, allowed to “rest” for 2 weeks, then sampled at 13 locations in each stall: the center, and at 12 locations midway between the center and the perimeter, corresponding to the numbers on a clock. The samples were pooled and cultured for coliform bacteria.

Experiment 2. Soiled bedding from the stalls was distributed to a depth of 4 inches among 4 square trays, 8 inches by 8 inches by 5 inches. The trays were divided into 2 groups of 2 trays each. Group 2-a trays were filled to a depth of 4 inches with soiled bedding from the 3 stalls, which was already visibly dry, and allowed to sit at room temperature for an additional 48 hours. The bedding was sampled by taking approximately 1 gram ‘core samples’ (surface-to-bottom) from each of 13 locations in each tray: the center, and 12 locations midway between the center and the periphery, corresponding to the numbers on a clock. Samples from each tray were pooled and cultured for coliform bacteria. Group 2-b trays were filled to a depth of 4 inches with soiled bedding from the 3 stalls, which was already visibly dry. The bedding was surface-sprayed with a household phenolic disinfectant sufficient for bedding 2 inches deep to be visibly damp 30 minutes later, then allowed to air-dry until visibly dry (4 hours). The bedding was sampled using the same method as in the 2-a trays.

Experiment 3. A sample of the clean bedding was cultured for coliform bacteria. The remainder was distributed to a depth of 4 inches among 12 square trays, 8 inches by 8 inches by 5 inches. Each tray was contaminated with 100 grams of fresh horse manure and 100 cc tap water. The manure was macerated with a fork to break up the manure balls and mixed into the bedding, and the trays of bedding were left at room temperature for 24 hours, then divided into 6 groups of 2 trays each. Group 3-a trays were cleaned of manure by picking visible pieces out with a sterile disposable eating fork (a separate fork per tray) until only those fragments that fell between the tines of the fork remained. Immediately after cleaning, the bedding was sampled by taking approximately 1 gram ‘core samples’ (surface-to-bottom) from each of 13 locations in each tray: the center, and 12 locations midway between the center and the periphery, corresponding to the numbers on a clock. The samples were pooled and cultured for coliform bacteria. Group 3-b trays were treated the same as Group 3-a trays, but were allowed to air-dry until visibly dry (48 hours) after being picked clean with a fork, then sampled in the same manner as with the Group 3-a trays. The samples were pooled and cultured for coliform bacteria. Group 3-c trays were treated the same as Group 3-a trays, but were allowed to air-dry until visibly dry (48 hours) after being picked clean with a fork, then surface-sprayed with a household phenolic disinfectant (Lysol®) sufficient for bedding 2 inches deep to be visibly damp 30 minutes later, then allowed to air dry until visibly dry (2 hours). Samples were then taken in the same manner as with the Group 3-a trays. The samples were pooled and cultured for coliform bacteria. Group 3-d trays were treated the same as Group 3-a trays, but were allowed to air-dry until visibly dry (48 hours) after being picked clean with a fork, then surface-sprayed with a common veterinary chlorhexidine diacetate disinfectant (Nolvasan®) sufficient for bedding 2 inches deep to be visibly damp 30 minutes later, then allowed to air dry until visibly dry (2 hours). Samples were then taken in the same manner as with the Group 3-a trays. The samples were pooled and cultured for coliform bacteria. Group 3-e trays were treated the same as Group 3-a trays, but were allowed to air-dry until visibly dry (48 hours) after being picked clean with a fork, then flooded with a household phenolic disinfectant (Lysol®), drained, and allowed to air dry until visibly dry (3 hours). Samples were then taken in the same manner as with the Group 3-a trays. The samples were pooled and cultured for coliform bacteria. Group 3-f trays were treated the same as Group 3-a trays, but were allowed to air-dry until visibly dry (48 hours) after being picked clean with a fork, then flooded with a common veterinary chlorhexidine disinfectant (Nolvasan®) and allowed to air dry until visibly dry (3 hours). Samples were then taken in the same manner as with the Group 3-a trays. The samples were pooled and cultured for coliform bacteria.

Results

Experiment 1. Cultures from the bedding taken from stalls that had been empty for 12 days after being occupied 12 hours per day for 6 months yielded no coliforms.

Experiment 2. Samples (2-a) taken from the stalls and allowed to air-dry indoors for 48 hours also yielded no coliforms. No coliforms were found after those air-dried samples were sprayed with a household phenolic disinfectant solution (2-b).

Experiment 3. Culture of clean bedding produced no growth. Cultures of bedding contaminated for 24 hours, picked of gross manure, and sampled without drying (3-a) produced over 1,000,000 cfu (colony-forming units) of coliforms per gram of bedding. Two cultures from samples picked and dried 48 hours (3-b) produced 1,000 and 18,000 cfu coliforms/gram, respectively. Two cultures from samples picked, dried, and sprayed with a household phenolic disinfectant (3-c) produced 65,000 and 1,000 cfu coliforms/gram, respectively. Two cultures from samples picked, dried, and sprayed with a common veterinary chlorhexidine diacetate disinfectant (3-d) each produced 200 cfu coliforms/gram. Culture of bedding picked, dried, then flooded with phenolic disinfectant, drained, and air-dried produced 100 cfu coliforms/gram. Culture of bedding picked, dried, then flooded with chlorhexidine disinfectant, drained, and air-dried produced no coliforms.

Discussion

Stalls bedded with the kilned bentonite clay product (Equidry™) and inhabited by draft horses 12 hours every day for 6 months, with manure removed daily but no attempt to deal with urine, consistently produced no coliforms when cultured after they were allowed to remain empty for 12 days. Two of the stalls had also been used during the study period for foaling of draft foals, and as such had been significantly wetted midway through the study period with allantoic fluid. The samples for culture included surface and bottom bedding. This suggests that desiccation occurs throughout the bedding layer and is sufficient to kill coliform bacteria.

Samples from the mock stalls in trays in the laboratory showed a dramatic reduction in coliform efu/gram when given a 48-hour drying time, from over a million (there was no attempt to count past 1,000,000) cfu/g in the wet samples, with the highest post-drying coliform count of 18,000 cfu and the lowest of 1,000 cfu. Treating with household phenolic solution produced variable results, with the highest post-treatment coliform count of 65,000 cfu and the lowest of 100 cfu, depending on method of application. Treating with chlorhexidine solution resulted in a low of 0 to a high of 200 coliform cfu/gram. It is likely that the drying time prior to application of disinfectant, and contact time of disinfectant with bedding granules, had an effect on culture results.

[image]

### CONCLUSION

Overall the results suggest that hygienic conditions may be achieved when the kilned clay bedding is allowed to dry sufficiently to kill pathogens through desiccation. In every one of six cultures on samples taken from the stalls left fallow for 12 days, regardless of whether and how those samples were treated after collection, the coliform count was 0. The inability of common disinfectants to achieve this consistently in samples air-dried for only 48 hours pre-treatment is likely due to reduced drying time prior to disinfection, and insufficient volume of disinfectant to achieve adequate contact with all the surface area in the experimental “stalls.” This is supported by the fact that samples from the pans that were flooded with disinfectant, then immediately drained and allowed to air-dry, achieved much lower coliform counts (0 to 200 cfu/gram of bedding) than did samples from the pans that were surface-sprayed with disinfectant.

Thus, for the exemplary purposes of this disclosure, use of Equidry™ horse bedding in accordance with disinfecting method embodiments of the invention provides many advantages over conventional horse beddings. Equidry™ granules have high hardness coupled with high absorbency, thereby rendering the bedding, dust and odor free, easy to clean, disinfect, and maintain, inexpensive, and long lasting, durable, and reusable in contrast to conventional beddings.

Because Equidry™ horse bedding granules are sufficiently hard, they have a very high resistance to crushing/powdering under the horse's weight. In addition, there is less dust produced when the horse kicks up the hard granules, or when Equidry™ is placed in the stall.

Additionally, Equidry™ horse bedding effectively and efficiently absorbs and desiccates the waste deposited by the horse over time. The absorption of moisture from the horse fecal waste leaves it desiccated so that it is not as offensive in odor production as its moist counterpart. Over time, absorbed moisture and ammonia are dissipated from the surface and porous structures of Equidry™ granules with the result that moisture/odor is controlled along with a corresponding reduction in fly problems. Therefore, Equidry™ reduces wet spots in the stall, and in doing so chemically ties up or partitions off the bulk of ammonia in the horse's wastes leaving a clean, dry, and relatively odor free stall environment.

Furthermore, Equidry™ horse bedding has a lower unit density than conventional bedding products. Particularly, Equidry™ density (approximately 20-70 lbs/ft³ depending upon the percentage of fines and kilning) is lighter than sand or gravel (125 lbs/ft³). This lower density caused by the designed porosity of the granules also imparts to Equidry™ a lower thermal mass. A lower thermal mass equates to a cooler product when compared to heavier natural ground surfaces (i.e., sands and gravels) because of the heat loss mechanism provided by each granule's high surface area.

Moreover, use of Equidry™ horse bedding results in lower medical, material, maintenance, and labor costs. For example, dust free Equidry™ lowers animal medical maintenance costs from respiratory and allergic reactions. In addition, by using Equidry™, a horse stays cleaner (i.e., Equidry™ does not get tangled in the horse's mane or tail and the horse's hooves stay better conditioned since the bedding does not pack in the hoof frogs). Furthermore, the daily labor requirement for cleaning a stall is reduced because Equidry™ may be easily maintained to a like new condition by a vacuum/blower. Particularly, Equidry™ weight/volume is lighter than sand or gravel as previously described, but is heavier than shavings, sawdust, straw, and other less absorbent organic products, thereby allowing blowing and/or vacuuming as a stall cleaning option. Moreover, Equidry™ is capable of remaining in place for long periods of time without replacement or maintenance/reconditioning due to its superior hardness and absorbency. Equidry™ has been in actual stall tests where it has lasted six to twelve months. As needed, blowing and/or vacuuming may recondition Equidry™ to its installed condition by removing fines introduced by animal waste breakdown.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation. Similarly, any steps or sequence of steps of the method of the present invention indicated herein are given as examples of possible steps or sequence of steps and not as limitations, since numerous disinfecting processes and sequences of steps may be used to disinfect stalls and animal bedding.

1. A method of disinfecting soiled animal bedding for reuse, the method comprising:
covering the soiled animal bedding to create a controlled environment around the animal bedding;
supplying an airborne disinfecting medium to the controlled environment around the animal bedding; and
reusing the animal bedding.

2. The method of claim 1, further comprising removing contaminants from the soiled animal bedding prior to disinfecting.

3. The method of claim 1, further comprising removing the soiled animal bedding from its first location of use to a disinfecting location different than the first location of use prior to disinfecting.

4. The method of claim 3, wherein reusing the animal bedding comprises returning the animal bedding to one of the first location of use and a second location of use different than the first location of use.

5. The method of claim 1, wherein reusing the animal bedding comprises reusing the animal bedding in its first location of use.

6. The method of claim 1, wherein supplying an airborne disinfecting medium comprises:
flooding the controlled environment around the animal bedding with a first airborne disinfecting medium selected to destroy pathogens requiring an anaerobic environment to survive; and
flooding the controlled environment around the animal bedding with a second airborne disinfecting medium selected to destroy pathogens requiring an aerobic environment to survive.

7. The method of claim 1, wherein supplying an airborne disinfecting medium comprises flooding the controlled environment around the animal bedding with one of an aspirated disinfecting medium selected to destroy pathogens and a gaseous disinfecting medium selected to destroy pathogens.

8. The method of claim 1, wherein supplying an airborne disinfecting medium comprises one of flooding the controlled environment around the animal bedding with saturated steam to destroy pathogens and autoclaving the animal bedding with saturated steam and a pressure of at least approximately 100 psi to destroy pathogens.

9. The method of claim 8 further comprising drying the animal bedding by one of evaporation and dry-heating.

10. A method of disinfecting soiled animal bedding for reuse, the method comprising:
rinsing the soiled animal bedding with a disinfecting medium selected to destroy pathogens;
drying the animal bedding; and
reusing the animal bedding.

11. The method of claim 10, further comprising removing contaminants from the soiled animal bedding prior to disinfecting.

12. The method of claim 10, further comprising removing the soiled animal bedding from its first location of use to a disinfecting location different than the first location of use prior to disinfecting.

13. The method of claim 12, wherein reusing the animal bedding comprises returning the animal bedding to one of the first location of use and a second location of use different than the first location of use.

14. The method of claim 10, wherein reusing the animal bedding comprises reusing the animal bedding in its first location of use.

15. The method of claim 10, wherein rinsing the soiled animal bedding comprises one of spraying a disinfecting medium on the animal bedding with an applicator, immersing the soiled animal bedding into a disinfecting medium bath, and washing soiled animal bedding on at least one vibrating screen under a spray bath.

16. The method of claim 10, wherein drying rinsed animal bedding comprises one of evaporation and dry-heating.

17. A method of disinfecting soiled animal bedding for reuse, the method comprising:
heating the soiled animal bedding; and
reusing the animal bedding.

18. The method of claim 17, further comprising removing contaminants from the soiled animal bedding prior to disinfecting.

19. The method of claim 17, further comprising removing the soiled animal bedding from its first location of use to a disinfecting location different than the first location of use prior to disinfecting.

20. The method of claim 19, wherein reusing the animal bedding comprises returning the animal bedding to one of the first location of use and a second location of use different than the first location of use.

21. The method of claim 17, wherein reusing the animal bedding comprises reusing the animal bedding in its first location of use.

22. The method of claim 17, wherein heating the soiled animal bedding comprises one of kilning the soiled animal bedding, torching the soiled animal bedding, and dry-heating the soiled animal bedding.

23. A method of disinfecting soiled animal bedding for reuse, the method comprising:
irradiating the soiled animal bedding with one of ultraviolet energy, microwave energy, gamma energy, and any combination thereof; and
reusing the animal bedding.

24. The method of claim 23, further comprising removing contaminants from the soiled animal bedding prior to disinfecting.

25. The method of claim 23, further comprising removing the soiled animal bedding from its first location of use to a disinfecting location different than the first location of use prior to disinfecting.

26. The method of claim 25, wherein reusing the animal bedding comprises returning the animal bedding to one of the first location of use and a second location of use different than the first location of use.

27. The method of claim 23, wherein reusing the animal bedding comprises reusing the animal bedding in its first location of use.

28. A method of disinfecting soiled horse bedding in a horse stall for reuse, the method comprising:
removing contaminants from the horse bedding in the horse stall;
disinfecting the horse bedding in the horse stall; and
reusing the horse bedding in the horse stall.

29. The method of claim 28, wherein removing contaminants from the horse bedding comprises separating contaminants from the horse bedding by one of cyclonic separation, gravity separation, and mechanical agitation.

30. The method of claim 28, wherein removing contaminants from the horse bedding comprises removing contaminants from horse bedding comprising granules each having at least 3% by weight of calcium bentonite clay and at least 3% by weight of at least one of illite clay and kaolinite clay.

31. The method of claim 28, wherein removing contaminants from the horse bedding comprises removing contaminants from horse bedding having a density of between approximately 20 lb/ft³ and approximately 70 lb/ft³.

32. The method of claim 28, wherein removing contaminants from the horse bedding comprises removing contaminants from horse bedding having an LA Abrasion hardness value of less than approximately 40.

33. The method of claim 28, wherein removing contaminants from the horse bedding comprises removing contaminants from horse bedding having an absorption capacity of approximately 0.5 ml/g to approximately 2.5 ml/g.

34. The method of claim 28, wherein removing contaminants from the horse bedding comprises removing contaminants from horse bedding having an absorption capacity of approximately 1.4 ml/g to approximately 1.9 ml/g.

35. The method of claim 28, wherein removing contaminants from the horse bedding comprises removing contaminants from horse bedding having an absorption rate in a 52 mm diameter column of approximately 90 milliliters or more within 10 minutes.

36. The method of claim 28, wherein removing contaminants from the horse bedding comprises removing contaminants from horse bedding having a surface area greater than approximately 2,000,000 ft²/ft³.

37. The method of claim 28, wherein removing contaminants from the horse bedding comprises removing contaminants from horse bedding having a size between approximately 4 mesh to approximately 50 mesh.

38. The method of claim 28, wherein disinfecting the horse bedding comprises disinfecting by:
covering the horse bedding to create a controlled environment around the horse bedding; and
supplying an airborne disinfecting medium to the controlled environment around the horse bedding.

39. The method of claim 38, wherein supplying an airborne disinfecting medium comprises:
flooding the controlled environment around the horse bedding with a first airborne disinfecting medium selected to destroy pathogens requiring an anaerobic environment to survive; and
flooding the controlled environment around the horse bedding with a second airborne disinfecting medium selected to destroy pathogens requiring an aerobic environment to survive.

40. The method of claim 38, wherein supplying an airborne disinfecting medium comprises flooding the controlled environment around the horse bedding with one of an aspirated disinfecting medium selected to destroy pathogens and a gaseous disinfecting medium selected to destroy pathogens.

41. The method of claim 38, wherein supplying an airborne disinfecting medium comprises flooding the controlled environment around the horse bedding with saturated steam to destroy pathogens or autoclaving the horse bedding with saturated steam and a pressure of at least approximately 100 psi to destroy pathogens.

42. The method of claim 41 further comprising drying the horse bedding by one of evaporation and dry-heating.

43. The method of claim 28, wherein disinfecting the horse bedding comprises disinfecting by:
rinsing the horse bedding with a disinfecting medium selected to destroy pathogens; and
drying the horse bedding.

44. The method of claim 43, wherein rinsing the horse bedding comprises one of spraying a disinfecting medium on the horse bedding with an applicator, immersing the horse bedding into a disinfecting medium bath, and washing the horse bedding on at least one vibrating screen under a spray bath.

45. The method of claim 43, wherein drying the horse bedding comprises one of evaporation and dry-heating.

46. The method of claim 28, wherein disinfecting the horse bedding comprises heating the horse bedding.

47. The method of claim 46, wherein heating the horse bedding comprises one of kilning the horse bedding, torching the horse bedding, and dry-heating the horse bedding.

48. The method of claim 28, wherein disinfecting the horse bedding comprises irradiating the horse bedding with one of ultraviolet energy, microwave energy, gamma energy, and any combination thereof.

49. An animal bedding disinfecting system for supplying at least one disinfecting medium to animal bedding to disinfect the animal bedding for reuse, the disinfecting system comprising:
a cover configured to create a controlled environment within an animal stall containing the animal bedding; and
at least one disinfecting medium reservoir associated with the cover and configured to supply the at least one disinfecting medium to the animal bedding within the controlled environment.

50. The animal bedding disinfecting system of claim 49, wherein the cover is configured to couple to side walls of the animal stall to create at least a partially sealed controlled environment.

51. The animal bedding disinfecting system of claim 49 further comprising a control device associated with the at least one disinfecting medium reservoir, wherein the at least one disinfecting medium reservoir is further configured to supply the at least one disinfecting medium to the controlled environment in response to stimuli from the control device.

52. The animal bedding disinfecting system of claim 51, wherein the at least one disinfecting medium comprises a first gas selected to destroy pathogens that require an aerobic atmosphere to survive and a second gas selected to destroy pathogens that require an anaerobic atmosphere to survive, and wherein the at least one disinfecting medium reservoir comprises first and second gas tanks associated with the control device, the first gas tank configured to supply the first gas to the controlled environment in response to stimuli from the control device, and the second gas tank configured to supply the second gas to the controlled environment in response to stimuli from the control device.

53. The animal bedding disinfecting system of claim 51, wherein the at least one disinfecting medium comprises an aspirated disinfecting medium selected to destroy pathogens, and wherein the at least one disinfecting medium reservoir comprises an aerosol canister associated with the control device and configured to supply the aspirated disinfecting medium to the controlled environment in response to stimuli from the control device.

54. The animal bedding disinfecting system of claim 51 further comprising at least one remote sensor associated with the control device, the least one remote sensor configured to be located in the controlled environment and to measure disinfecting medium concentration therein and transmit respective stimuli dependent thereon to the control device.

55. The animal bedding disinfecting system of claim 49 further comprising an inlet valve associated with the cover and configured to receive therethrough the at least one disinfecting medium.

56. The animal bedding disinfecting system of claim 49 further comprising a ventilation system associated with flooring of the animal stall, the ventilation system configured to receive therethrough the at least one airborne disinfecting medium.

57. A horse bedding disinfecting system for supplying heat to horse bedding to disinfect the horse bedding for reuse, the disinfecting system comprising a heating cover configured both to create a controlled environment within a horse stall containing the horse bedding and to supply heat at a temperature of at least approximately 200° F. for a time period of at least approximately 5 minutes to the horse bedding.

58. The horse bedding disinfecting system of claim 57, wherein the heating cover is configured to couple to side walls of the animal stall to create at least a partially sealed controlled environment.

59. The horse bedding disinfecting system of claim 57 further comprising a control device associated with the heating cover, wherein the heating cover is further configured to supply heat to the controlled environment in response to stimuli from the control device.

60. The horse bedding disinfecting system of claim 59 further comprising at least one remote sensor associated with the control device, the least one remote sensor configured to be located in the controlled environment and to measure temperature therein and transmit respective stimuli dependent thereon to the control device
